(19) United States
(12) Patent Application Publication
(10) Pub. No.: US 2019/0303566 A1
(43) Pub. Date: Oct. 3, 2019

(54) ATTACK DETECTOR, CONTROLLER, AND ATTACK DETECTION METHOD

(71) Applicant: MegaChips Corporation, Osaka (JP)

(72) Inventor: Hajime YOSHIMURA, Osaka (JP)

(73) Assignee: MegaChips Corporation, Osaka (JP)

(21) Appl. No.: 16/365,660

(22) Filed: Mar. 26, 2019

(30) Foreign Application Priority Data
Mar. 30, 2018 (JP) 2018-067467

(51) Int. Cl. G06F 21/55; G06F 21/75

(52) U.S. Cl. CPC G06F 21/552; G06F 2221/034; G06F 21/755

(57) ABSTRACT

An attack detector includes first circuitry. The first circuitry is configured to detect occurrence of level change of power or a signal supplied to a predetermined circuit. The first circuitry is configured to store a first attack evaluation value indicating a degree of probability that an attack on the predetermined circuit has occurred. The first circuitry is configured to update the first attack evaluation value based on a detection result of the occurrence of the level change. The first circuitry is configured to perform first determination of determining whether or not the attack has occurred based on the first attack evaluation value.

### CROSS-REFERENCE TO RELATED APPLICATION

The present application claims priority to Japanese Patent Application 2018-067467 filed by the Japanese Patent Office on Mar. 30, 2018, the entire contents of which are incorporated herein by reference.

### BACKGROUND OF THE INVENTION

### Field of the Invention

The present invention relates to detection of an attack on a circuit.

### Description of the Background Art

Japanese Patent Application Laid-Open No. 2001-318130 discloses a technology of detecting glitch included in an output signal of a device to be tested.

### SUMMARY

In one aspect, an attack detector includes first circuitry. The first circuitry is configured to detect occurrence of level change of power or a signal supplied to a predetermined circuit. The first circuitry is configured to store a first attack evaluation value indicating a degree of probability that an attack on the predetermined circuit has occurred. The first circuitry is configured to update the first attack evaluation value based on a detection result of the occurrence of the level change. The first circuitry is configured to perform first determination of determining whether or not the attack has occurred based on the first attack evaluation value.

In one aspect, a controller includes the above-mentioned attack detector, and a second circuitry configured to control the predetermined circuit when it is determined that the attack has occurred in the attack detector.

In one aspect, a processing device includes the above-mentioned controller, and the predetermined circuit controlled by the controller.

In one aspect, an attack detection method is an attack detection method used in an attack detector configured to detect an attack on a predetermined circuit. The attack detection method includes detecting occurrence of level change of power or a signal supplied to the predetermined circuit. The attack detection method includes updating an attack evaluation value indicating a degree of probability that the attack has occurred based on a detection result of the occurrence of the level change. The attack detection method includes determining whether or not the attack has occurred based on the updated attack evaluation value.

### BRIEF DESCRIPTION OF THE DRAWINGS

FIG. 1 is a diagram showing one example of a configuration of a processing device.

FIG. 2 is a diagram showing one example of a configuration of a processing circuit.

FIG. 3 is a diagram showing one example of a configuration of a controller.

FIG. 4 is a flowchart showing one example of operation of an updater.

FIG. 5 is a diagram showing one example of a configuration of the controller.

FIG. 6 is a diagram showing one example of a configuration of the controller.

FIG. 7 is a flowchart showing one example of operation of the updater.

FIG. 8 is a diagram showing one example of a state in which level change occurs in an execution period.

FIG. 9 is a diagram showing one example of a state in which level change occurs in the execution period.

FIG. 10 is a diagram showing one example of a configuration of the controller.

FIG. 11 is a diagram showing one example of a state in which level change occurs in the execution period.

FIG. 12 is a diagram showing one example of a state in which level change occurs in the execution period.

FIG. 13 is a diagram showing one example of a state in which level change successively occurs in a repeatedly appearing plurality of execution periods.

FIG. 14 is a flowchart showing one example of operation of the updater.

FIG. 15 is a diagram for illustrating one example of operation of the updater.

FIG. 16 is a diagram for illustrating one example of operation of the updater.

FIG. 17 is a flowchart showing one example of operation of the updater.

FIG. 18 is a diagram for illustrating one example of operation of the updater.

FIG. 19 is a flowchart showing one example of operation of the updater.

FIG. 20 is a diagram for illustrating one example of operation of the updater.

FIG. 21 is a diagram for illustrating one example of operation of the updater.

FIG. 22 is a flowchart showing one example of operation of the updater.

FIG. 23 is a diagram for illustrating one example of operation of the updater.

FIG. 24 is a flowchart showing one example of operation of the updater.

FIG. 25 is a flowchart showing one example of operation of the updater.

FIG. 26 is a flowchart showing one example of operation of the updater.

FIG. 27 is a flowchart showing one example of operation of the updater.

FIG. 28 is a flowchart showing one example of operation of the updater.

FIG. 29 is a flowchart showing one example of operation of the updater.

FIG. 30 is a diagram for illustrating one example of operation of the updater.

FIG. 31 is a diagram for illustrating one example of operation of the updater.

FIG. 32 is a diagram showing one example of attack evaluation values corresponding to respective partial periods.

FIG. 33 is a diagram showing one example of evaluation value ratios corresponding to respective partial periods.

FIG. 34 is a diagram showing one example of a configuration of an attack detector.

### DESCRIPTION OF THE PREFERRED EMBODIMENTS

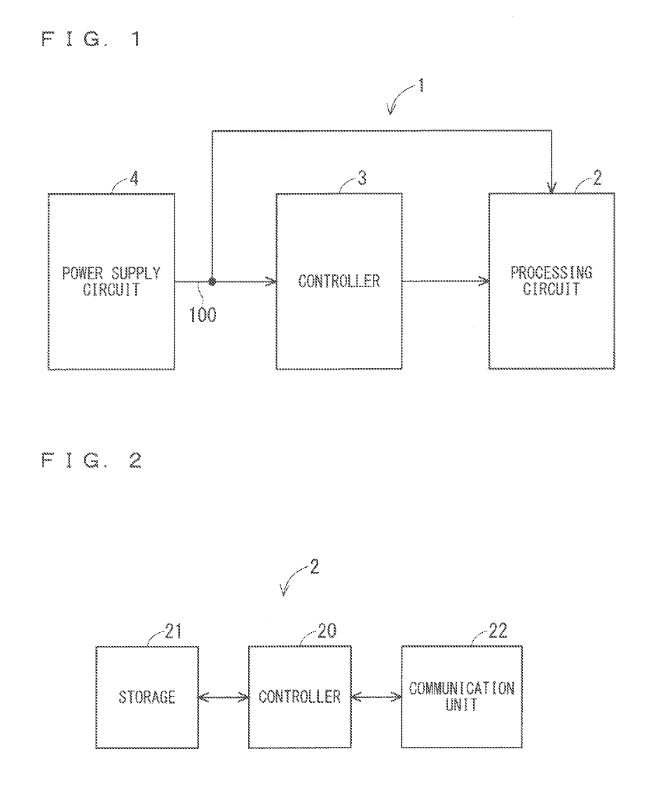

FIG. 1 is a diagram showing one example of a configuration of a processing device 1. The processing device 1 can, for example, perform a plurality of types of processing, including communication processing for communicating with another device or the like. The processing device 1 is, for example, a circuit that can be used in a mobile phone such as a smartphone, a tablet terminal, a personal computer, a wearable device, a game machine, a projector, an on-board device such as a car navigation device, a drone device, a terminal for Internet of Things (IoT), or the like.

As shown in FIG. 1, the processing device 1 includes a processing circuit 2 that can perform a plurality of types processing including communication processing or the like, a controller 3 that can control the processing circuit 2, and a power supply circuit 4 that can supply power 100 to the processing circuit 2 and the controller 3. The power supply circuit 4 can, for example, generate the power 100 based on electricity supplied from a rechargeable battery. Further, the power supply circuit 4 may generate the power 100 based on electricity supplied from a commercial power supply, or may generate the power 100 based on electricity supplied from an AC adapter. The power 100 is, for example, a direct-current voltage.

The controller 3, the processing circuit 2, and the power supply circuit 4 may be formed of one die, or may be formed of a plurality of dies. The die is also referred to as a wafer chip. Further, the controller 3, the processing circuit 2, and the power supply circuit 4 may be housed in one package made of resin or the like, or may be housed in separate packages. Further, two of the controller 3, the processing circuit 2, and the power supply circuit 4 may be housed in one package.

Various examples of the processing device 1 are described below.

### First Example

<Configuration Example of Processing Circuit>

FIG. 2 is a diagram showing one example of a configuration of the processing circuit 2 according to this example. As shown in FIG. 2, for example, the processing circuit 2 includes circuitry including a controller 20, a storage 21, and a communication unit 22. The storage 21 includes a computer-readable non-transitory recording medium, such as read only memory (ROM) and random access memory (RAM). The storage 21 stores a control program or the like for controlling the processing circuit 2. It can also be said that the storage 21 is a storage circuit.

The controller 20 can integrally manage operation of the processing circuit 2 by controlling other components of the processing circuit 2. It can also be said that the controller 20 is a control circuit. The controller 20 includes, for example, a central processing unit (CPU). Various functions of the controller 20 are implemented by the CPU included in the controller 20 executing the control program in the storage 21.

The communication unit 22 is connected to a communication network including at least one of a wireless network and a wired network. The communication unit 22 can communicate with another device via the communication network. The communication network includes, for example, a network for a mobile phone system including a base station or the like, a wireless local area network (LAN), the Internet, or the like. It can also be said that the communication unit 22 is a communication circuit.

The processing circuit 2 including the configuration as described above can operate based on a clock signal supplied from the controller 3. As described later, the controller 3 can stop the operation of the processing circuit 2 by not supplying a clock signal to the processing circuit 2.

Further, in the processing circuit 2, the controller 20 can perform encryption processing of encrypting data. The data encrypted by the controller 20 is, for example, stored in the storage 21, or transmitted from the communication unit 22 to another device. Further, the controller 20 can perform decryption processing of decrypting the encrypted data. The data decrypted by the controller 20 is, for example, stored in the storage 21. Further, the controller 20 can execute authentication processing of authenticating a user of the processing device 1.

Note that the processing executed by the processing circuit 2 is not limited to the above examples. Further, the configuration of the processing circuit 2 is not limited to the example of FIG. 2. For example, the controller 20 may include a plurality of CPUs. Further, the controller 20 may include at least one digital signal processor (DSP). Further, all of the functions of the controller 20 or a part of the functions of the controller 20 may be implemented by a hardware circuit in which software is not required to implement functions of the hardware circuit.

Further, the storage 21 may include a computer-readable non-transitory recording medium other than the ROM and the RAM. The storage 21 may include, for example, a small-sized hard disk drive, a solid state drive (SSD), or the like.

<Configuration Example of Controller>

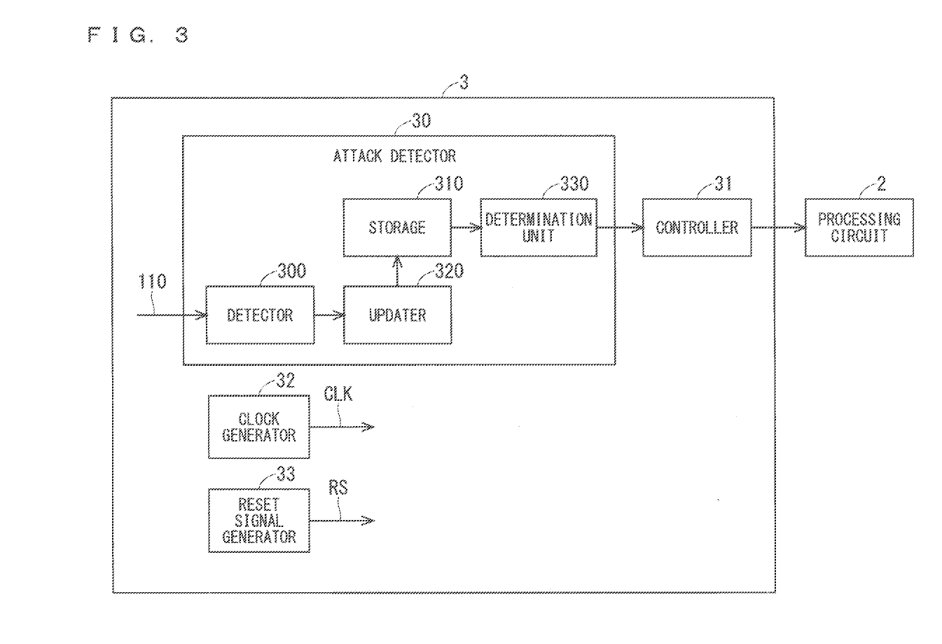

FIG. 3 is a diagram showing one example of a configuration of the controller 3 according to this example. As shown in FIG. 3, for example, the controller 3 includes circuitry including an attack detector 30, a controller 31, a clock generator 32, and a reset signal generator 33. It can also be said that the controller 3 is a control circuit. The clock generator 32 and the reset signal generator 33 may be provided separately from the controller 3.

Here, with the aim of acquiring confidential information from a circuit or the like, an attack may be carried out on the circuit by intentionally changing a level of power or a signal supplied to the circuit. For example, an attack on a circuit to be attacked may be carried out by intentionally causing glitch in a level of power or a signal supplied to the circuit to be attacked. The glitch is spike-like short-duration transient decrease or increase in a level. Such an attack is referred to as a glitch attack, and is one type of fault injection attacks. The fault injection attack may be referred to as a fault attack or fault injection analysis. The term “fault injection attack” by itself hereinafter refers to an attack of intentionally changing a level of power or a signal supplied to a circuit to be attacked.

In the fault injection attack, processing of intentionally decreasing or increasing a level of power or a signal supplied to a circuit to be attacked to thereby cause an error in the operation of the circuit to be attacked and acquire an operation state of the circuit to be attacked at the time may be repeatedly executed. Then, in the fault injection attack, confidential information of the circuit to be attacked may be estimated based on the state of the erroneous operation of the circuit to be attacked that is collected by the repeated execution of the processing.

For example, a case where a key used in encryption processing of a circuit to be attacked that performs the encryption processing is estimated in the fault injection attack is considered. In this case, processing of intentionally decreasing or increasing a level of power or a signal supplied to the circuit to be attacked to thereby cause an error in the encryption processing and acquire a result of the encryption processing at the time is repeatedly executed. Then, the erroneous result of the encryption processing that is collected by the repeated execution of the processing and a correct result of the encryption processing are compared with each other, and the key used in the encryption processing is estimated based on a comparison result of the comparison.

In this manner, in the fault injection attack, change in a level of power or a signal supplied to a circuit to be attacked from an original value may repeatedly occur.

In view of this, the controller 3 according to this example detects occurrence of level change in the power 100 or a signal supplied to the processing circuit 2, and determines whether or not an attack on the processing circuit 2 has occurred based on the detection result. With this, the fault injection attack on the processing circuit 2 can be properly detected. Then, when the controller 3 determines that an attack on the processing circuit 2 has occurred, the controller 3 can enhance safety of the processing circuit 2 by controlling the processing circuit 2.

Here, target level change of the controller 3 refers to change from an original value. Therefore, level change detected by the controller 3 concerning a signal that originally changes its levels as in a clock signal that repeats High levels and Low levels does not include such original level change. For example, when the controller 3 detects occurrence of level change of a clock signal, the controller 3 detects occurrence of change from an original value at timing when a High level of the clock signal is expected, or occurrence of change from the original value at timing when a Low level is expected.

The controller 3 is described in detail below. The power 100 or the signal supplied to the processing circuit 2 may be hereinafter referred to as a “monitor target.” Further, a level of the monitor target may be referred to as a monitor target level 110. Further, the term “level change” or “level decrease” by itself refers to change(s) or decrease(s) in the monitor target level 110. Further, the term “glitch” by itself refers to glitch that occurs in the monitor target level 110.

In this example, the controller 3 is formed by a hardware circuit in which software is not required to implement functions of the hardware circuit. Therefore, in this example, the controller 3 does not include a processor such as a CPU, and a program executed by the processor. Note that all of the functions of the controller 3 or a part of the functions of the controller 3 may be implemented by using software. In other words, all of the functions of the controller 3 or a part of the functions of the controller 3 may be implemented by the processor such as a CPU executing the program.

The clock generator 32 generates a clock signal CLK that serves as a reference of the operation of the processing device 1. It can also be said that the clock generator 32 is a clock generator circuit. The clock signal CLK is supplied to an internal circuit including the attack detector 30 etc. The internal circuit is included in the controller 3. Further, the clock signal CLK is also supplied to the processing circuit 2. The controller 3 and the processing circuit 2 are circuits that operate based on the clock signal CLK. The clock generator 32 may include a crystal oscillator, or may include an oscillator that does not use crystals. Examples of the oscillator that does not use crystals include an oscillator using micro electro mechanical systems (MEMS).

The reset signal generator 33 generates a reset signal RS, and outputs the generated reset signal RS. It can also be said that the reset signal generator 33 is a reset signal generator circuit. The reset signal RS is input to an internal circuit including the attack detector 30 etc., and is also input to the processing circuit 2. The internal circuit is included in the controller 3.

When a reset switch included in the processing device 1 is operated, the reset signal generator 33 asserts the reset signal RS for a certain period of time. With this, when the reset switch is operated, the processing device 1 is restarted, and operation of each of the controller 3 and the processing circuit 2 is initialized. Further, when a state of the power supply circuit 4 is switched from a state of not outputting the power 100 to a state of outputting the power 100, the reset signal generator 33 asserts the reset signal RS for a certain period of time. With this, when a state of the power supply circuit 4 is switched from a state of not outputting the power 100 to a state of outputting the power 100, the processing device 1 is restarted, and operation of each of the controller 3 and the processing circuit 2 is initialized.

The attack detector 30 detects occurrence of change in the monitor target level 110, and determines whether or not an attack on the processing circuit 2 has occurred based on the detection result. In this example, the attack detector 30 detects occurrence of glitch in the monitor target level 110, and determines whether or not an attack on the processing circuit 2 has occurred based on the detection result. It can be said that the attack detector 30 is an attack detector circuit. The monitor target level 110 is, for example, a level of the power 100 or a level of the clock signal CLK.

The attack detector 30 includes, for example, a detector 300, a storage 310, an updater 320, and a determination unit 330. It can be said that the detector 300, the storage 310, the updater 320, and the determination unit 330 are a detector circuit, a storage circuit, an updater circuit, and a determination circuit, respectively.

The detector 300 can detect occurrence of glitch in the monitor target level 110. The storage 310 stores an attack evaluation value that indicates a degree of probability that an attack on the processing circuit 2 has occurred.

The updater 320 updates the attack evaluation value in the storage 310 based on the detection result of the detector 300. Specifically, the updater 320 determines that level change (decrease or increase in the monitor target level 110) has occurred based on the detection result of the detector 300. Then, the updater 320 updates the attack evaluation value in the storage 310 in accordance with the occurrence of level change. In this example, the updater 320 updates the attack evaluation value in the storage 310 in accordance with the occurrence of glitch in the monitor target level 110. More specifically, the updater 320 increases the attack evaluation value in the storage 310 in accordance with the occurrence of glitch. With this, as the number of times of occurrence of glitch is increased, the attack evaluation value is increased accordingly. Specifically, it can be said that as the number of times of occurrence of glitch is increased, there is high probability that an attack on the processing circuit 2 has occurred. The determination unit 330 determines whether or not an attack on the processing circuit 2 has occurred based on the attack evaluation value in the storage 310. To increase the attack evaluation value may be hereinafter referred to as to count up the attack evaluation value.

For example, the controller 31 can control the processing circuit 2 by controlling supply of the clock signal CLK to the processing circuit 2. In this example, the controller 31 can activate the processing circuit 2 by supplying the clock signal CLK to the processing circuit 2. Further, the controller 31 can stop the operation of the processing circuit 2 by stopping the supply of the clock signal CLK to the processing circuit 2. When the determination unit 330 determines that an attack on the processing circuit 2 has occurred, the controller 31 stops the supply of the clock signal CLK to the processing circuit 2 to stop the operation of the processing circuit 2. With this, when the fault injection attack on the processing circuit 2 occurs, the operation of the processing circuit 2 can be stopped. Consequently, the probability that the confidential information of the processing circuit 2 is acquired can be reduced. As a result, safety of the processing circuit 2 is enhanced.

When the supply of the clock signal CLK to the processing circuit 2 is stopped to stop the operation of the processing circuit 2, for example, a user can make the processing device 1 restore the operation of the processing circuit 2 by operating the reset switch. When the reset switch is operated, the reset signal generator 33 asserts the reset signal RS for a certain period of time. With this, the operation of the processing device 1 is initialized. When the operation of the processing device 1 is initialized, the controller 31 starts supplying the clock signal CLK to the processing circuit 2. With this, the stopped processing circuit 2 resumes the operation.

Note that, as described above, when a state of the power supply circuit 4 is switched from a state of not outputting the power 100 to a state of outputting the power 100, the reset signal generator 33 asserts the reset signal RS for a certain period of time. Therefore, if the processing device 1 is provided with a power supply switch that can control the output of the power 100 of the power supply circuit 4, the user can make the processing device 1 resume the operation of the processing circuit 2 by operating the power supply switch.

A method in which the controller 31 stops the operation of the processing circuit 2 is not limited to the above example. For example, when the determination unit 330 determines that an attack on the processing circuit 2 has occurred, the controller 31 may assert a reset signal for the processing circuit 2 to stop the operation of the processing circuit 2. In this case, for example, when the reset signal RS is asserted, the controller 31 asserts the reset signal for the processing circuit 2 that is input to the processing circuit 2. Further, the clock signal CLK generated by the clock generator 32 is directly input to the processing circuit 2. Then, when the operation of the processing device 1 is initialized, the controller 31 negates the reset signal for the processing circuit 2. With this, the user can make the processing device 1 resume the operation of the processing circuit 2 by operating the reset switch or the like.

<Detailed Description on Attack Detector>

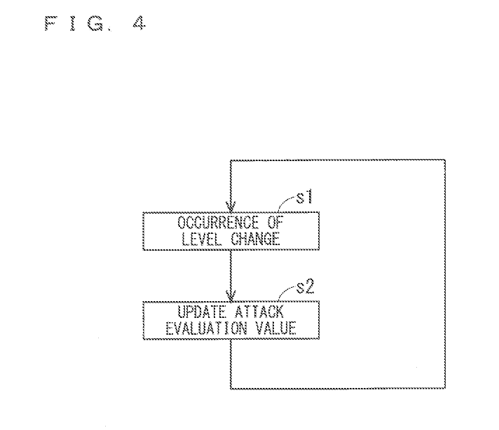

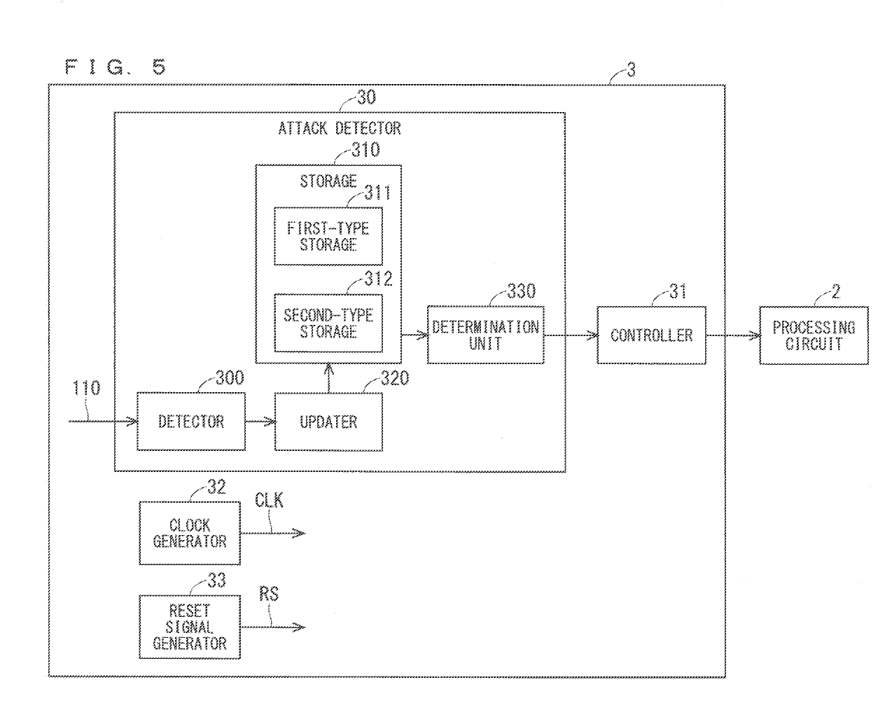

Next, one example of the operation of the attack detector 30 according to this example is described in detail. FIG. 4 is a flowchart showing one example of operation of the updater 320 included in the attack detector 30. FIG. 4 shows update processing for the attack evaluation value in the updater 320. The updater 320 continuously executes the update processing shown in FIG. 4 during activation of the processing device 1.

As shown in FIG. 4, when the updater 320 determines in Step s1 that level change (glitch, in this example) has occurred based on a detection result of the detector 300, the updater 320 updates an attack evaluation value in the storage 310 in Step s2. Specifically, the updater 320 increases the attack evaluation value. For example, the updater 320 increases the attack evaluation value only by +1. After that, when Step s1 is executed again (when level change occurs), the updater 320 increases the attack evaluation value only by +1 in Step s2. The updater 320 operates similarly thereafter.

In this manner, in this example, the updater 320 increases the attack evaluation value every time level change, such as level decrease, occurs. Therefore, as the number of times of occurrence of level change is increased, the attack evaluation value is increased accordingly. As described above, in the fault injection attack, glitch may repeatedly occur in a level of power or a signal supplied to a circuit to be attacked. Therefore, when the number of times of occurrence of glitch is large, it can be said that there is high probability that an attack on the processing circuit 2 has occurred. Thus, it can be said that as the attack evaluation value that depends on the number of times of occurrence of glitch is increased, there is high probability that an attack on the processing circuit 2 has occurred. In this example, the attack evaluation value is increased only by +1 every time glitch occurs. Further, an initial value of the attack evaluation value is set to zero, for example. Therefore, the attack evaluation value indicates the number of times of occurrence of glitch. It can be said that the attack evaluation value indicates the number of times of occurrence of level change.

The determination unit 330 performs attack determination processing of determining whether or not an attack on the processing circuit 2 has occurred based on the attack evaluation value in the storage 310 at predetermined timing. In the attack determination processing, the determination unit 330 compares the attack evaluation value in the storage 310 and a threshold value, and determines whether or not an attack on the processing circuit 2 has occurred based on a comparison result of the comparison. Specifically, when the attack evaluation value is greater than the threshold value, the determination unit 330 determines that an attack on the processing circuit 2 has occurred. On the other hand, when the attack evaluation value is equal to or less than the threshold value, the determination unit 330 determines that an attack on the processing circuit 2 has not occurred. Note that the determination unit 330 may determine that an attack on the processing circuit 2 has occurred when the attack evaluation value is equal to or greater than the threshold value, and may determine that an attack on the processing circuit 2 has not occurred when the attack evaluation value is less than the threshold value. Processing of executing certain processing when a certain value is greater than a threshold value, and executing different processing when the certain value is equal to or less than the threshold value may be hereinafter replaced by processing of executing the certain processing when the certain value is equal to or greater than the threshold value, and executing the different processing when the certain value is less than the threshold value. Similarly, processing of executing certain processing when a certain value is equal to or greater than a threshold value, and executing different processing when the certain value is less than the threshold value may be hereinafter replaced by processing of executing the certain processing when the certain value is greater than the threshold value, and executing the different processing when the certain value is equal to or less than the threshold value.

As the timing when the determination unit 330 executes the attack determination processing, various timings are conceivable. For example, the determination unit 330 may execute the attack determination processing every Nth time (N>1) the updater 320 updates the attack evaluation value in the storage 310. Alternatively, the determination unit 330 may execute the attack determination processing every certain period of time.

The threshold value used in the attack determination processing is, for example, determined depending on types of the storage 310 that stores the attack evaluation value. As the types of the storage 310, for example, there are a first type in which stored information is cleared in response to power disconnection and reset of the attack detector 30, and a second type in which stored information is not cleared in response to power disconnection and reset of the attack detector 30. If the storage 310 is of the first type, the storage 310 may be hereinafter referred to as a “first-type storage 310.” Further, if the storage 310 is of the second type, the storage 310 may be hereinafter referred to as a “second-type storage 310.”

The first-type storage 310 is, for example, formed of volatile memory. As the volatile memory, for example, RAM or a register is adopted. When the supply of the power 100 to the controller 3 is stopped to cause power disconnection of the attack detector 30, supply of the power to the first-type storage 310 stops. As a result, information in the storage 310 formed of the volatile memory is cleared. Further, when the reset signal generator 33 asserts the reset signal RS by operation on the reset switch or the like while the power 100 is supplied to the controller 3, the information in the first-type storage 310 formed of the volatile memory is cleared. Specifically, when the attack detector 30 is reset while the power 100 is supplied to the controller 3, the information in the first-type storage 310 is cleared. Therefore, the information in the first-type storage 310 is cleared when the attack detector 30 is restarted. In other words, the information in the first-type storage 310 is cleared when the processing device 1 is restarted.

As can be understood from the description above, the attack evaluation value in the first-type storage 310 is not cleared during activation of the attack detector 30, but is cleared when power disconnection or reset of the attack detector 30 occurs. In other words, the attack evaluation value in the first-type storage 310 is not cleared during activation of the processing device 1, but is cleared when power disconnection or reset of the processing device 1 occurs. Therefore, it can be said that the attack evaluation value in the first-type storage 310 is a value that indicates a degree of probability that an attack has occurred during one-time activation of the processing device 1.

When the first-type storage 310 stores the attack evaluation value, the threshold value used in the attack determination processing is, for example, determined based on a predicted maximum number of times of occurrence of level change (such as glitch) due to noise or the like when an attack on the processing circuit 2 does not occur during one-time activation of the processing device 1. The predicted maximum number of times of occurrence may be hereinafter referred to as a “predicted maximum number of times of occurrence of level change during one-time activation.” The threshold value is, for example, set to a value slightly greater than the predicted maximum number of times of occurrence of level change during one-time activation.

The predicted maximum number of times of occurrence of level change during one-time activation varies depending on a period of time of one-time activation of the processing device 1, an environment in which the processing device 1 is used, or the like. If the processing device 1 is a device that has a relatively short period of time of one-time activation, such as a projector, a car navigation device, and a drone device, the predicted maximum number of times of occurrence of level change during one-time activation is relatively small. On the other hand, if the processing device 1 is a device used in an environment in which the device is subjected to noise from the surroundings, the predicted maximum number of times of occurrence of level change during one-time activation is relatively large. The predicted maximum number of times of occurrence of level change during one-time activation may be determined based on an experiment using an actual device or a simulation. The threshold value compared with the attack evaluation value in the first-type storage may be hereinafter referred to as a “first-type threshold value.”

The second-type storage 310 is, for example, formed of non-volatile memory. As the non-volatile memory, for example, flash memory (flash ROM) or one time programmable read only memory (OTPROM) is adopted. As the flash memory, for example, NAND flash memory, serial peripheral interface (SPI) flash memory, or embedded flash memory may be adopted. The information in the second-type storage 310 formed of the non-volatile memory is not cleared even when the supply of the power 100 to the controller 3 is stopped to cause power disconnection of the attack detector 30. Further, even when the reset signal generator 33 asserts the reset signal RS while the power 100 is supplied to the controller 3, the information in the second-type storage 310 is not cleared.

In this manner, the information in the second-type storage 310 is not cleared during activation of the attack detector 30, and is also not cleared even when the attack detector 30 is restarted.

When the second-type storage 310 stores the attack evaluation value, the threshold value used in the attack determination processing is, for example, determined based on a predicted maximum number of times of occurrence of level change due to noise or the like when an attack on the processing circuit 2 does not occur in a product life of the processing device 1. The predicted maximum number of times of occurrence may be hereinafter referred to as a “predicted maximum number of times of occurrence of level change in a product life.” The threshold value is, for example, set to a value slightly greater than the predicted maximum number of times of occurrence of level change in a product life.

The predicted maximum number of times of occurrence of level change in a product life varies depending on a product life of the processing device 1, an environment in which the processing device 1 is used, or the like. For example, as the product life of the processing device 1 is longer, the predicted maximum number of times of occurrence of level change in a product life is increased accordingly. Further, if the processing device 1 is a device used in an environment in which the device is not liable to be subjected to noise from the surroundings, the predicted maximum number of times of occurrence of level change in a product life is relatively small. The predicted maximum number of times of occurrence of level change in a product life may be determined based on an experiment using an actual device or a simulation. The threshold value compared with the attack evaluation value in the second-type storage may be hereinafter referred to as a “second-type threshold value.”

Note that, when the second-type storage 310 is used, the attack evaluation value in the second-type storage 310 is not cleared even when the processing device 1 is reset. Therefore, even when the attack evaluation value in the second-type storage 310 exceeds the second-type threshold value to cause the controller 31 to stop the operation of the processing circuit 2 and subsequently the processing device 1 is reset to resume the operation of the processing circuit 2, the operation of the processing circuit 2 is immediately stopped. In light of this, the information in the second-type storage 310 may be able to be cleared by inputting a command to the processing device 1 from the outside of the processing device 1.

Further, when the second-type storage 310 is used, the determination unit 330 may execute the attack determination processing every time the attack detector 30 is restarted, i.e., every time the processing device 1 is restarted.

Further, in the fault injection attack on the processing circuit 2, not the spike-like transient level change as glitch, but trapezoidal transient level change that causes longer change in the monitor target level 110 than the glitch may repeatedly occur. The detector 300 may detect such trapezoidal transient level change instead of the glitch. Further, the detector 300 may detect both of the glitch and the trapezoidal transient level change.

As described above, in this example, whether or not an attack on the processing circuit 2 has occurred is determined based on the attack evaluation value updated based on the detection result of the detector 300 that detects occurrence of level change. Therefore, an attack on the processing circuit 2 can be properly detected.

Further, as in this example, when the determination unit 330 determines that an attack on the processing circuit 2 has occurred, safety of the processing circuit 2 can be enhanced by the controller 31 controlling the processing circuit 2.

Further, when the first-type storage 310 is adopted, the attack evaluation value in the storage 310 indicates a degree of probability that an attack occurs during one-time activation of the processing device 1. Therefore, the attack detector 30 can properly detect an attack occurring during one-time activation.

As the attack on the processing circuit 2, a fault injection attack of repeatedly executing processing of restarting the processing device 1 and subsequently causing level change (such as glitch) is also conceivable, other than the fault injection attack of repeatedly causing level change during one-time activation of the processing device 1. The attack detector 30 including the first-type storage 310 may be unable to detect such an attack of repeatedly causing restart.

In contrast, if the storage 310 is of the second type, the attack evaluation value in the storage 310 is not cleared even when the attack detector 30 is restarted. Therefore, the attack detector 30 including the second-type storage 310 can properly detect the attack of repeatedly causing restart.

Further, if the second-type storage 310 is formed of the OTPROM, the attack evaluation value in the second-type storage 310 is hardly manipulated. Consequently, safety of the attack detector 30 is enhanced. Note that, if the second-type storage 310 is formed of the OTPROM, data cannot be written a plurality of times to a storage area of the second-type storage 310 having the same address. Therefore, when the updater 320 writes an updated attack evaluation value to the second-type storage 310, the updater 320 writes the updated attack evaluation value to a storage area different from a storage area that has stored the attack evaluation value.

Note that, when restart of the attack detector 30 occurs repeatedly, there is high probability that the above-mentioned attack of repeatedly causing restart is being carried out on the processing circuit 2.

In view of this, if the storage 310 is of the second type, the determination unit 330 may decrease the second-type threshold value only by a predetermined amount (e.g., “1”) every time the attack detector 30 is restarted. In other words, the determination unit 330 may decrease the second-type threshold value only by a predetermined amount every time the attack detector 30 is reset. With this, the determination unit 330 can detect the attack of repeatedly causing restart early.

### Second Example

FIG. 5 is a diagram showing a configuration of the controller 3 included in the processing device 1 according to this example. The storage 310 of the controller 3 shown in FIG. 5 includes a first-type storage 311 and a second-type storage 312 in the controller 3 shown in FIG. 3 described above.

Each of the first-type storage 311 and the second-type storage 312 stores an attack evaluation value. The attack evaluation value stored in the first-type storage 311 may be hereinafter referred to as a “first attack evaluation value.” Further, the attack evaluation value stored in the second-type storage 312 may be hereinafter referred to as a “second attack evaluation value.” An initial value of each of the first and second attack evaluation values is set to zero, for example.

In this example, the updater 320 updates the first attack evaluation value in the first-type storage 311 based on the detection result of the detector 300. Further, the updater 320 updates the second attack evaluation value in the second-type storage 312 based on the detection result of the detector 300. For example, the updater 320 updates the first attack evaluation value in the first-type storage 311 based on the detection result of the detector 300 every time level change occurs as in FIG. 4 described above. Similarly, the updater 320 updates the second attack evaluation value in the second-type storage 312 based on the detection result of the detector 300 every time level change occurs.

Here, as described above, the first-type storage is a storage in which stored information is cleared in response to power disconnection and reset of the attack detector 30. Therefore, the first attack evaluation value in the first-type storage 311 returns to the initial value in response to power disconnection and reset of the attack detector 30. In contrast, the second-type storage is a storage in which stored information is not cleared in response to power disconnection and reset of the attack detector 30. Therefore, the second attack evaluation value in the second-type storage 312 basically does not return to the initial value in a product life of the processing device 1. Thus, the first and second attack evaluation values eventually differ even if the first and second attack evaluation values have the same initial values. The first attack evaluation value is a value that indicates a degree of probability that an attack has occurred during one-time activation. The second attack evaluation value is not cleared even when the processing device 1 is restarted.

In this example, the determination unit 330 determines whether or not an attack on the processing circuit 2 has occurred based on the first attack evaluation value in the first-type storage 311 and the second attack evaluation value in the second-type storage 312. For example, when the first attack evaluation value is equal to or greater than the first-type threshold value, the determination unit 330 determines that an attack on the processing circuit 2 has occurred. Further, when the second attack evaluation value is equal to or greater than the second-type threshold value, the determination unit 330 determines that an attack on the processing circuit 2 has occurred. Further, when the first attack evaluation value is less than the first-type threshold value, and the second attack evaluation value is less than the second-type threshold value, the determination unit 330 determines that an attack on the processing circuit 2 has not occurred. Note that the determination unit 330 may determine that an attack on the processing circuit 2 has occurred when the first attack evaluation value is greater than the first-type threshold value. Further, the determination unit 330 may determine that an attack on the processing circuit 2 has occurred when the second attack evaluation value is greater than the second-type threshold value.

In this manner, whether or not an attack on the processing circuit 2 has occurred is determined based on the first attack evaluation value that indicates a degree of probability that an attack has occurred during one-time activation and the second attack evaluation value that is not reset even when the processing device 1 is restarted. Consequently, both of the fault injection attack of repeatedly causing level change during one-time activation of the processing device 1 and the fault injection attack of repeatedly executing restart of the processing device 1 can be detected properly.

Note that, similarly to the above-mentioned first example, the determination unit 330 may decrease the second-type threshold value that is compared with the second attack evaluation value in the second-type storage 312 every time the attack detector 30 is restarted.

### Third Example

The controller 3 included in the processing device 1 according to this example includes a configuration similar to the configuration of the controller 3 shown in FIG. 3 described above. Further, as compared to the controller 3 shown in FIG. 3 described above, the controller 3 included in the processing device 1 according to this example is different in the operation of the determination unit 330 and the controller 31.

The determination unit 330 according to this example determines a degree of a risk of an attack on the processing circuit 2 based on a comparison result between the attack evaluation value in the storage 310 and each of a plurality of threshold values that are different from each other. The controller 31 according to this example changes control over the processing circuit 2 depending on the degree of the risk of the attack determined by the determination unit 330.

If the storage 310 is of the first type, the determination unit 330 determines a degree of a risk of an attack on the processing circuit 2 based on a comparison result between the attack evaluation value in the storage 310 and each of a plurality of first-type threshold values that are different from each other. If the storage 310 is of the second type, the determination unit 330 determines a degree of a risk of an attack on the processing circuit 2 based on a comparison result between the attack evaluation value in the storage 310 and each of a plurality of second-type threshold values that are different from each other. Specific examples of the operation of the determination unit 330 and the controller 31 are described below.

For example, a case where the storage 310 is of the first type, and the determination unit 330 determines a degree of a risk of an attack on the processing circuit 2 based on a comparison result between the attack evaluation value and each of first-type first and second threshold values is considered. Note that the first-type second threshold value is greater than the first-type first threshold value. When the attack evaluation value is equal to or greater than the first-type first threshold value and is less than the first-type second threshold value, the determination unit 330 determines that the degree of the risk of the attack on the processing circuit 2 is low. On the other hand, when the attack evaluation value is equal to or greater than the first-type second threshold value, the determination unit 330 determines that the degree of the risk of the attack on the processing circuit 2 is high.

When the determination unit 330 determines that the degree of the risk of the attack is high, the controller 31 stops the operation of the processing circuit 2 as described above. On the other hand, when the determination unit 330 determines that the degree of the risk of the attack is low, the controller 31 outputs to the processing circuit 2 a notification signal for giving notice that the degree of the risk of the attack on the processing circuit 2 is low. It can also be said that the notification signal is a control signal for controlling the processing circuit 2. When the processing circuit 2 receives the notification signal from the controller 31, the processing circuit 2 executes attack countermeasure processing having a level of countermeasures against the attack lower than stopping the operation of the processing circuit 2. As the attack countermeasure processing, for example, the processing circuit 2 performs processing for protecting processing having high probability of being attacked from the attack in the processing performed by the processing circuit 2. As the processing having high probability of being attacked, for example, encryption processing, conditional branch processing, and processing of writing to the storage 21 are conceivable. It can be said that the processing of writing to the storage 21 is processing of writing to a storage area. The term “writing processing” by itself hereinafter simply refers to processing of writing to the storage 21.

As the attack on the encryption processing, for example, there is an attack of estimating a key used in the encryption processing. As the attack on the conditional branch processing, for example, there is an attack of executing a certain process at the branch destination in all cases. For example, conditional branch processing in authentication processing of comparing an input password and an authorized password stored in advance, and determining that the authentication has succeeded when both the passwords match, and determining that the authentication has failed when both the passwords do not match is considered. The conditional branch processing may be hereinafter referred to as “conditional branch processing for authentication.” As the attack on the conditional branch processing for authentication, for example, an attack of determining that the authentication has succeeded in all cases irrespective of whether or not the input password and the authorized password stored in advance match is conceivable. As the attack on the writing processing, there is an attack of writing erroneous data to the storage 21. When the processing circuit 2 receives the notification signal, for example, the processing circuit 2 performs processing of changing the key of the encryption processing as the processing for protecting the processing having high probability of being attacked from the attack. Alternatively, the processing circuit 2 performs processing of changing execution timing of the encryption processing. Alternatively, the processing circuit 2 performs processing of changing execution timing of the conditional branch processing. Alternatively, the processing circuit 2 performs processing of writing the same data a plurality of times to a storage area of the storage 310 having the same address. With this, safety of the processing circuit 2 is enhanced. Note that the processing performed by the processing circuit 2 that has received the notification signal from the controller 31 is not limited to the above. For example, the processing circuit 2 may perform a plurality of types of attack countermeasure processing.

As another example, for example, a case where the storage 310 is of the second type, and the determination unit 330 determines a degree of a risk of an attack on the processing circuit 2 based on a comparison result between the attack evaluation value and each of second-type first to third threshold values is considered. Note that the second-type third threshold value is greater than the second-type second threshold value, and the second-type second threshold value is greater than the second-type first threshold value. When the attack evaluation value is equal to or greater than the second-type first threshold value and is less than the second-type second threshold value, the determination unit 330 determines that the degree of the risk of the attack on the processing circuit 2 is low. Further, when the attack evaluation value is equal to or greater than the second-type second threshold value and is less than the second-type third threshold value, the determination unit 330 determines that the degree of the risk of the attack on the processing circuit 2 is medium. Then, when the attack evaluation value is equal to or greater than the second-type third threshold value, the determination unit 330 determines that the degree of the risk of the attack on the processing circuit 2 is high.

When the determination unit 330 determines that the degree of the risk of the attack is high, the controller 31 stops the operation of the processing circuit 2 as described above. Further, when the determination unit 330 determines that the degree of the risk of the attack is medium, the controller 31 outputs to the processing circuit 2 a first notification signal for giving notice that the degree of the risk of the attack on the processing circuit 2 is medium. Then, when the determination unit 330 determines that the degree of the risk of the attack is low, the controller 31 outputs to the processing circuit 2 a second notification signal for giving notice that the degree of the risk of the attack on the processing circuit 2 is low. It can also be said that each of the first and second notification signals are a control signal for controlling the processing circuit 2.

When the processing circuit 2 receives the first notification signal from the controller 31, the processing circuit 2 executes first attack countermeasure processing having a level of countermeasures against the attack lower than stopping the operation of the processing circuit 2. Further, when the processing circuit 2 receives the second notification signal from the controller 31, the processing circuit 2 executes second attack countermeasure processing having a level of countermeasures against the attack lower than the first attack countermeasure processing. As the first attack countermeasure processing, for example, changing the key used in the encryption processing is conceivable. As the second attack countermeasure processing, for example, changing the execution timing of the encryption processing is conceivable. Combination of the first attack countermeasure processing and the second attack countermeasure processing is not limited to the above.

Note that the determination unit 330 may determine the degree of the risk of the attack on the processing circuit 2 also in the above-mentioned second example. For example, the determination unit 330 may determine the degree of the risk of the attack on the processing circuit 2 based on a comparison result between the first attack evaluation value in the first-type storage 311 and each of the plurality of first-type threshold values that are different from each other. Further, the determination unit 330 may determine the degree of the risk of the attack on the processing circuit 2 based on a comparison result between the second attack evaluation value in the second-type storage 312 and each of the plurality of second-type threshold values that are different from each other. Similarly to the above, the controller 31 changes control over the processing circuit 2 depending on the degree of the risk determined by the determination unit 330.

As described above, in this example, a degree of a risk of an attack on the processing circuit 2 is determined. Therefore, countermeasures against the attack using the determination result can be implemented. For example, as described above, the controller 31 can change control over the processing circuit 2 depending on the degree of the risk determined by the determination unit 330. With this, proper control depending on the degree of the risk of the attack can be performed over the processing circuit 2.

Note that, similarly to the above-mentioned first example, if the storage 310 is of the second type, the determination unit 330 may decrease the plurality of second-type threshold values every time the attack detector 30 is restarted.

### Fourth Example

In the above example, the attack evaluation value in the storage 310 is unconditionally updated when level change occurs. Therefore, when many level changes due to noise unexpectedly occur, the attack detector 30 may erroneously determine that an attack on the processing circuit 2 has occurred.

In view of this, the processing device 1 according to this example updates the attack evaluation value in the storage 310 in accordance with occurrence of level change in a period of time in which predetermined processing is executed in the processing circuit 2. As the predetermined processing, for example, processing having high probability of being attacked in the processing executed by the processing circuit 2 is adopted. With this, even when many level changes due to noise unexpectedly occur, the probability that it is erroneously determined that an attack on the processing circuit 2 has occurred can be reduced. The processing device 1 according to this example is described in detail below.

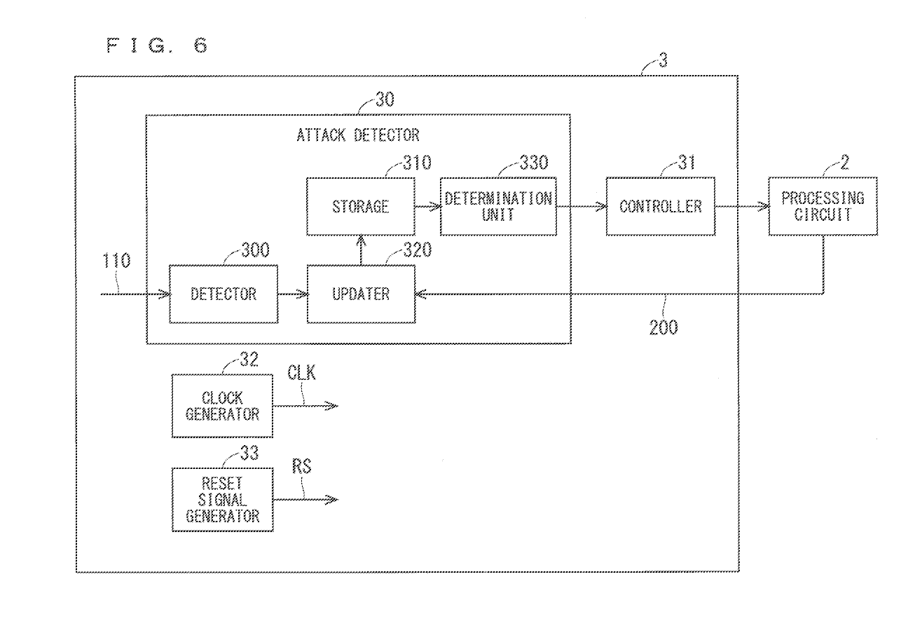

FIG. 6 is a diagram mainly showing a configuration of the controller 3 included in the processing device 1 according to this example. In this example, the updater 320 updates the attack evaluation value in the storage 310 in accordance with occurrence of level change in a period of time in which predetermined processing is executed in the processing circuit 2. The predetermined processing and the period of time are hereinafter referred to as “target processing” and “execution period,” respectively.

As the target processing, processing having high probability of being attacked in the processing executed by the processing circuit 2 is adopted. As the target processing, for example, encryption processing, conditional branch processing, or writing processing is adopted. The target processing may be repeatedly executed or may be executed only once during one-time activation of the processing device 1. Further, the target processing may be repeatedly executed when the target processing is executed every time the processing device 1 is activated.

The processing circuit 2 outputs period notification information 200 for giving notice of the execution period to the updater 320. The period notification information includes, for example, start notification information for giving notice of the start of the execution period, and end notification information for giving notice of the end of the execution period. It can also be said that the start notification information indicates start timing of the target processing. Further, it can also be said that the end notification information indicates end timing of the target processing. The processing circuit 2 outputs the start notification information to the updater 320 when the processing circuit 2 starts execution of the target processing. Then, the processing circuit 2 outputs the end notification information to the updater 320 when the processing circuit 2 ends the execution of the target processing.

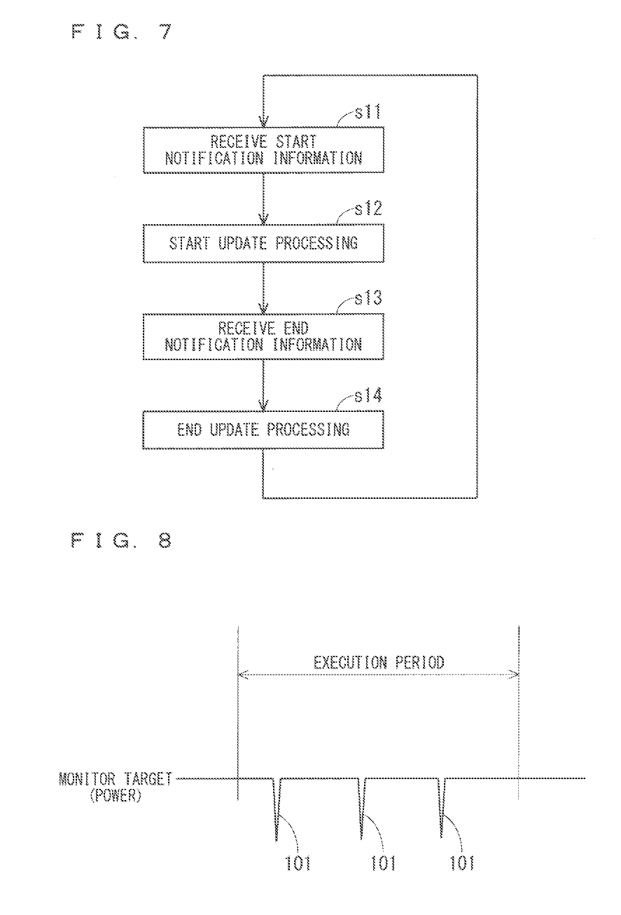

FIG. 7 is a flowchart showing one example of operation of the updater 320. As shown in FIG. 7, when the updater 320 receives the start notification information in Step s11, the updater 320 starts the update processing shown in FIG. 4 described above. After that, when the updater 320 receives the end notification information in Step s13, the updater 320 ends the update processing. After that, when the updater 320 receives the start notification information (Step s12), the updater 320 operates similarly thereafter.

In this manner, the updater 320 updates the attack evaluation value in the storage 310 as described above every time level change occurs in a period of time from when the updater 320 receives the start notification information from the processing circuit 2 until the updater 320 receives the end notification information. Specifically, the updater 320 updates the attack evaluation value in the storage 310 every time level change occurs in the execution period. On the other hand, the updater 320 does not update the attack evaluation value in the storage 310 even when level change occurs in a period of time other than the execution period.

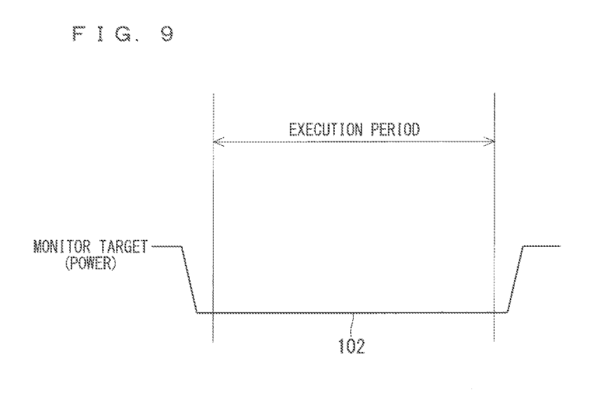

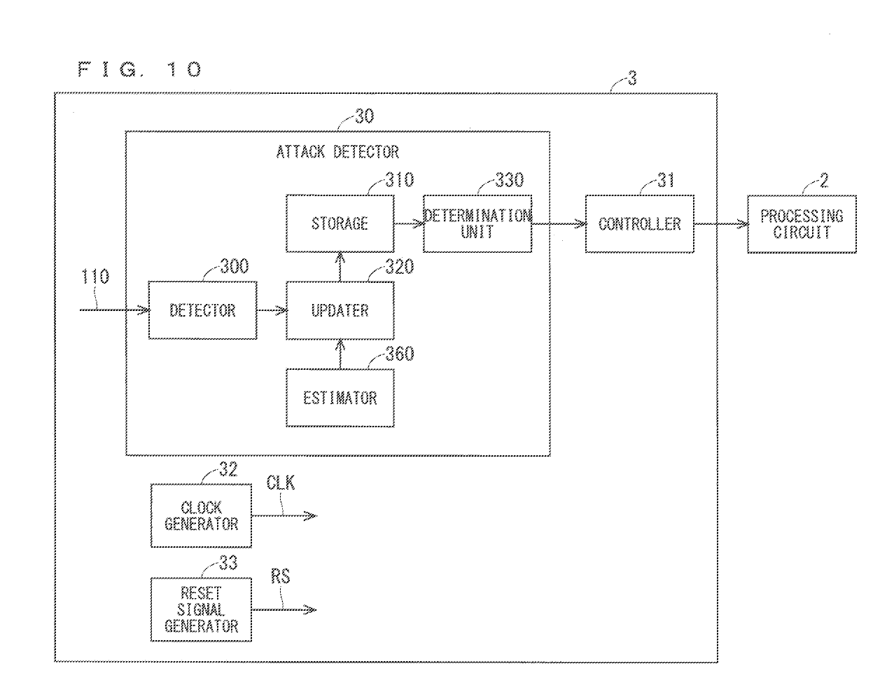

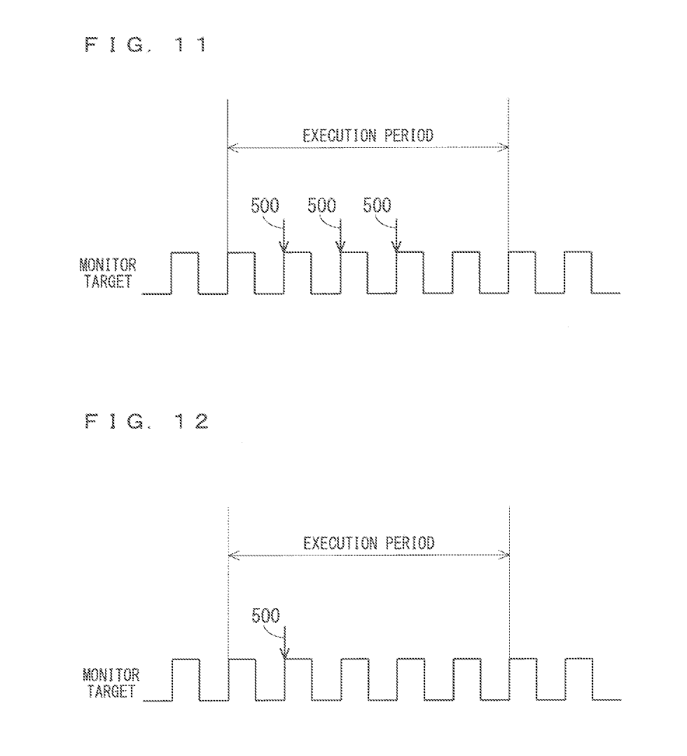

FIGS. 8 and 9 are each a diagram showing one example of a state in which level change occurs in the execution period. FIGS. 8 and 9 each show one example of level decrease when the monitor target is the power 100. FIG. 8 shows one example of a state in which glitch 101 occurs three times in the execution period. In the example of FIG. 8, the updater 320 updates the attack evaluation value three times in the execution period. FIG. 9 shows one example of a state in which trapezoidal level change 102 occurs only once in the execution period. In the example of FIG. 9, the updater 320 updates the attack evaluation value only once in the execution period.

Note that, although only one type of target processing is adopted in the above example, a plurality of types of target processing may be adopted. In this case, concerning each of the plurality of types of target processing, the updater 320 updates the attack evaluation value in the storage 310 in accordance with occurrence of level change in the execution period of the target processing. For example, a case where each of encryption processing, conditional branch processing, and writing processing is adopted as the target processing is considered. In this case, the processing circuit 2 notifies the updater 320 of an execution period of the encryption processing, an execution period of the conditional branch processing, and an execution period of the writing processing. The updater 320 updates the attack evaluation value in the storage 310 in accordance with occurrence of level change in the execution period of the encryption processing. Further, the updater 320 updates the attack evaluation value in the storage 310 in accordance with occurrence of level change in the execution period of the conditional branch processing. Then, the updater 320 updates the attack evaluation value in the storage 310 in accordance with occurrence of level change in the execution period of the writing processing.

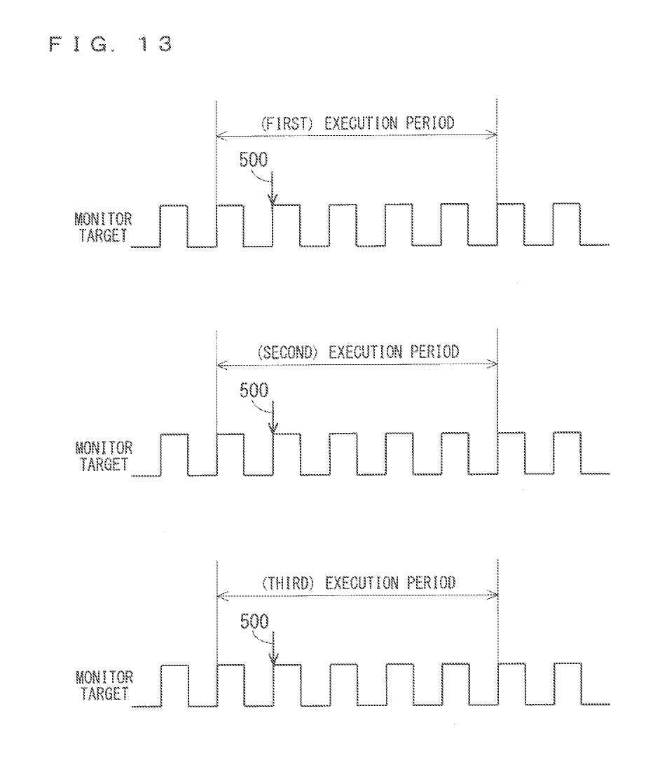

Further, although the attack detector 30 is notified of the execution period from the processing circuit 2 in the above example, the attack detector 30 may estimate the execution period by itself. With this, notification of the execution period from the processing circuit 2 is unnecessary. FIG. 10 is a diagram showing one example of a configuration of the attack detector 30 in this case.

The attack detector 30 shown in FIG. 10 includes an estimator 360 that estimates an execution period. The estimator 360 acquires a power consumption waveform of the processing circuit 2. For example, the estimator 360 detects an electric current flowing through a power supply line that connects the processing circuit 2 and the power supply circuit 4, and acquires a power consumption waveform of the processing circuit 2 based on the detected electric current. Then, the estimator 360 estimates the execution period based on the acquired power consumption waveform.

Here, the power consumption waveform of the processing circuit 2 when the processing circuit 2 executes target processing exhibits a specific waveform depending on the executed target processing. The estimator 360 stores a power consumption waveform of the processing circuit 2 when the processing circuit 2 executes target processing in advance as a reference waveform. Then, the estimator 360 compares acquired power consumption waveform and the reference waveform, and estimates the execution period based on a comparison result of the comparison. Specifically, the estimator 360 estimates start timing and end timing of the execution period based on the comparison result. The estimator 360 outputs the start notification information to the updater 320 at the start timing of the execution period. Further, the estimator 360 outputs the end notification information to the updater 320 at the end timing of the execution period. As shown in FIG. 7 described above, the updater 320 updates the attack evaluation value in the storage 310 every time level change occurs in a period of time from when the updater 320 receives the start notification information until the updater 320 receives the end notification information.

As described above, in this example, the updater 320 updates the attack evaluation value in the storage 310 in accordance with occurrence of level change in the execution period. Thus, even when many level changes due to noise unexpectedly occur, probability that it is erroneously determined that an attack on the processing circuit 2 has occurred can be reduced.

Note that, in the above-mentioned second example, the updater 320 may update the first attack evaluation value in the first-type storage 311 in accordance with occurrence of level change in the execution period. Further, the updater 320 may update the second attack evaluation value in the second-type storage 312 in accordance with occurrence of level change in the execution period.

Further, similarly to the above-mentioned first example, if the storage 310 is of the second type, the determination unit 330 may decrease the second-type threshold value every time the attack detector 30 is restarted.

### Fifth Example

In the above-mentioned fourth example, when an attack is carried out on the processing circuit 2, the attacker may make the processing circuit 2 repeatedly execute target processing. Then, the attacker may cause level change only once aiming at certain specific timing in the target processing every time the target processing is executed to cause an error in the operation of the processing circuit 2.

For example, a case where the processing circuit 2 performs target processing every time the processing device 1 is activated is considered. In this case, for example, the attacker repeatedly operates the reset switch to repeatedly restart the processing device 1, and makes the processing circuit 2 repeatedly execute the target processing. Then, the attacker causes level change (decrease or increase in the monitor target level 110) only once at certain timing in the target processing every time the target processing is executed. For example, when the target processing is encryption processing in accordance with Advanced Encryption Standard (AES) with a key length of 128 bits, the attacker repeatedly operates the reset switch to make the processing circuit 2 repeatedly execute the encryption processing. Then, the attacker causes level change only once at timing when the tenth round of the encryption processing is executed every time the target encryption processing is executed, and acquires an operation state of the processing circuit 2 performing erroneous operation.

Further, a case where an execution command for commanding execution of target processing can be input from the outside of the processing device 1 to the processing circuit 2 is considered. In this case, the attacker repeatedly inputs an execution command to the activated processing circuit 2 to make the processing circuit 2 repeatedly execute the target processing. Then, the attacker causes level change only once at certain timing in the target processing every time the target processing is executed. For example, when the target processing is the above-mentioned conditional branch processing for authentication, the attacker repeatedly inputs an execution command to the processing circuit 2 to make the processing circuit 2 repeatedly execute the conditional branch processing for authentication. Then, the attacker causes level change only once at specific timing in the conditional branch processing for authentication every time the conditional branch processing for authentication is executed, and acquires an operation state of the processing circuit 2 performing erroneous operation. As the specific timing, timing when processing of determining whether or not an input password and an authorized password stored in advance match is executed is conceivable.

In this manner, the attacker may make the processing circuit 2 repeatedly execute target processing to carry out an attack of causing level change only once during the execution of the target processing every time the target processing is executed. In other words, the attacker may repeatedly cause execution periods to carry out an attack of causing level change only once in a one-time execution period. Such an attack may be hereinafter referred to as “specific-timing attack.” In this example, the processing device 1 that can properly detect the specific-timing attack is described. As compared to the processing device 1 according to the above-mentioned fourth example, the processing device 1 according to this example is different in the operation of the updater 320.

In this example, the updater 320 does not update the attack evaluation value in the storage 310 when level change occurs a plurality of times in a one-time execution period. Then, the updater 320 updates the attack evaluation value in the storage 310 as described above when level change occurs only once in a one-time execution period. With this, when the specific-timing attack is carried out on the processing circuit 2, the attack evaluation value in the storage 310 is updated as appropriate. On the other hand, when level change occurs a plurality of times due to noise in a one-time execution period, the attack evaluation value is not updated. With this, the attack detector 30 can properly detect the specific-timing attack on the processing circuit 2.

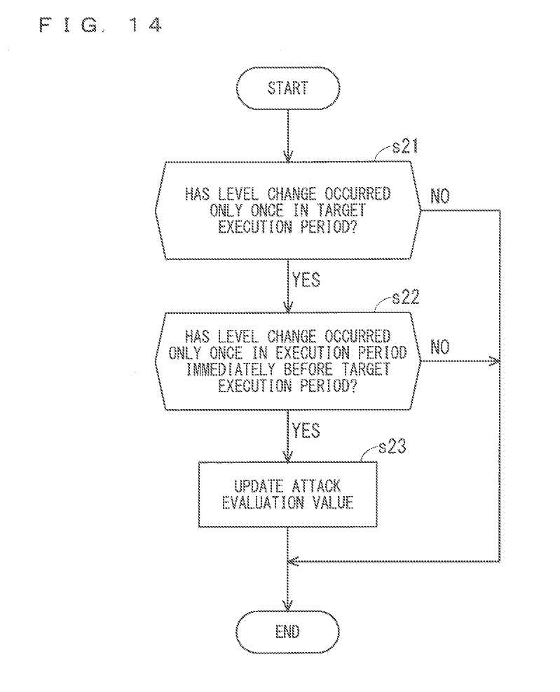

FIGS. 11 and 12 are each a diagram showing one example of a state in which level change occurs in a one-time execution period. In the examples of FIGS. 11 and 12, the monitor target is the clock signal CLK. Specifically, the monitor target level is a level of the clock signal CLK. Further, each arrow 500 of FIGS. 11 and 12 indicates timing when level change (e.g., glitch) occurs. It can also be said that the arrow 500 indicates timing when the detector 300 detects level change. In the example of FIG. 11, level change occurs three times in a one-time execution period, and therefore the attack evaluation value is not updated. On the other hand, in the example of FIG. 12, level change occurs only once in a one-time execution period, and therefore the attack evaluation value is updated to be increased only by +1, for example.

Note that, in the case where the updater 320 updates the first attack evaluation value in the first-type storage 311 in accordance with occurrence of level change in the execution period in the above-mentioned second example, the updater 320 need not update the first attack evaluation value when level change occurs a plurality of times in a one-time execution period. Further, in the case where the updater 320 updates the second attack evaluation value in the second-type storage 312 in accordance with occurrence of level change in the execution period, the updater 320 need not update the second attack evaluation value when level change occurs a plurality of times in a one-time execution period.

Further, similarly to the above-mentioned first example, if the storage 310 is of the second type, the determination unit 330 may decrease the plurality of second-type threshold values every time the attack detector 30 is restarted.

### Sixth Example

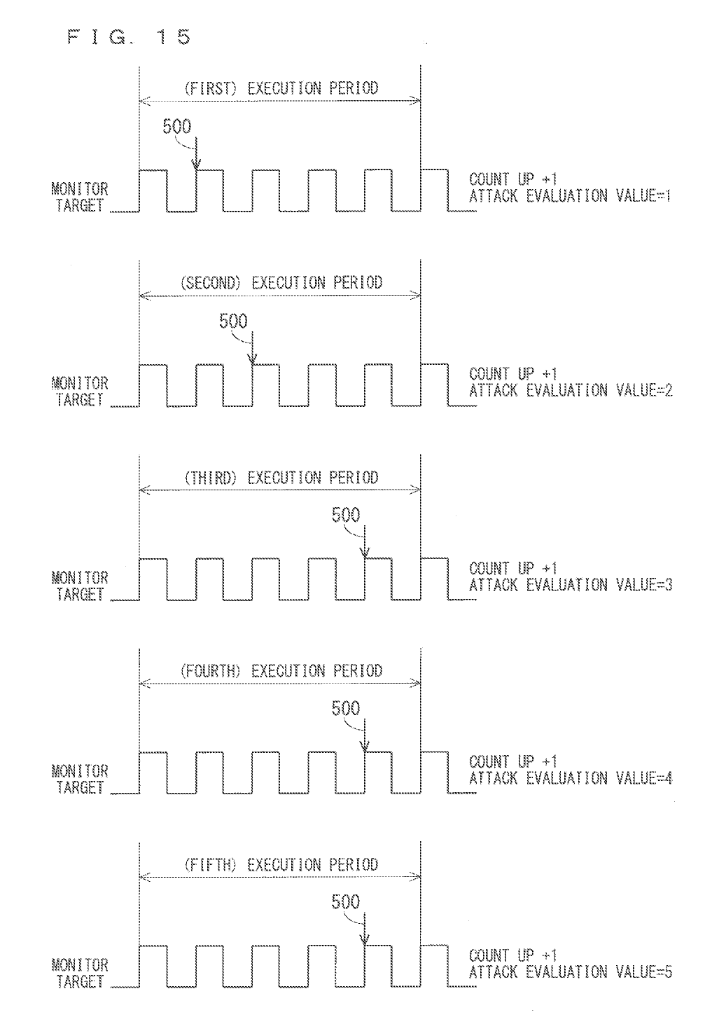

As described above, in the specific-timing attack, level change occurs during execution of target processing every time the target processing is executed. Specifically, in the specific-timing attack, level change successively occurs in a repeatedly appearing plurality of execution periods. FIG. 13 is a diagram showing one example of a state in which level change successively occurs in a repeatedly appearing plurality of execution periods. FIG. 13 shows a state in which level change successively occurs in first to third execution periods after activation of the processing device 1.

In this example, the updater 320 updates the attack evaluation value in the storage 310 based on successiveness of occurrence of level change between the repeatedly appearing plurality of execution periods. With this, the specific-timing attack on the processing circuit 2 can be more properly detected. Methods of updating the attack evaluation value based on successiveness of occurrence of level change between the repeatedly appearing plurality of execution periods are described below with reference to a plurality of examples.

### First Case of Sixth Example

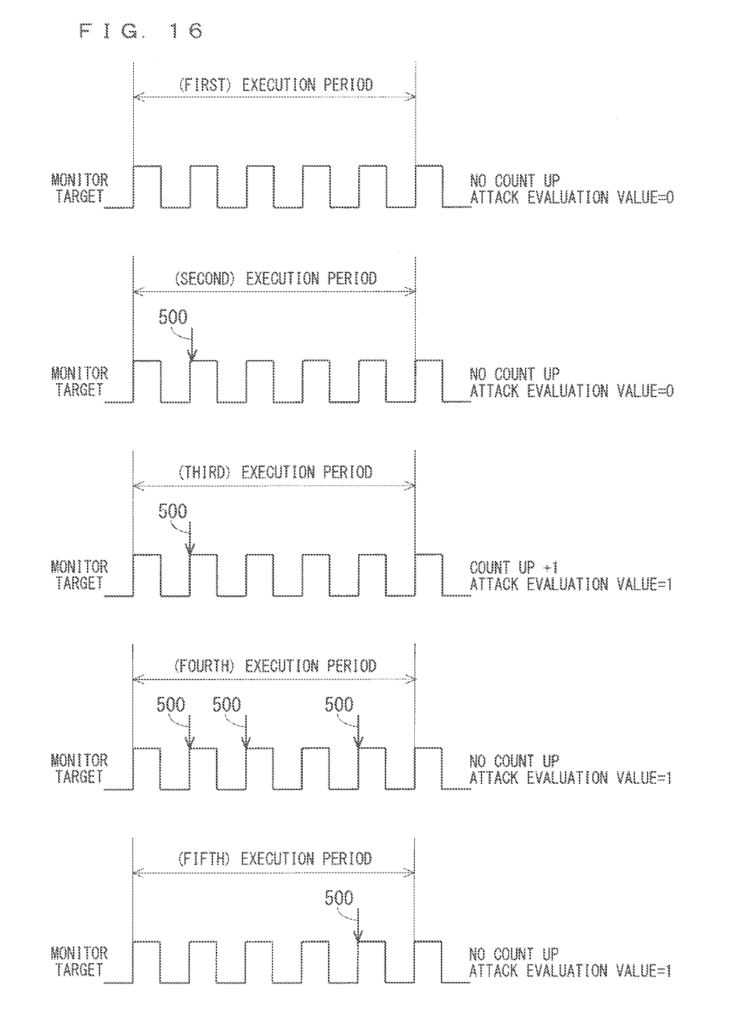

FIG. 14 is a flowchart showing one example of processing concerning one execution period performed by the updater 320 according to this example. The updater 320 executes the processing shown in FIG. 14 in each execution period. An execution period to be described may be hereinafter referred to as a “target execution period.”

As shown in FIG. 14, in Step s21, the updater 320 determines whether or not level change has occurred only once in a target execution period based on a detection result of the detector 300. For example, in the case as in FIG. 9 described above, it is determined that level change has occurred only once in a target execution period. When it is determined to be YES in Step s21, the updater 320 determines in Step s22 whether or not level change has occurred only once in an execution period immediately before the target execution period based on the detection result of the detector 300. On the other hand, when it is determined to be NO in Step s21, the updater 320 ends the processing concerning the target execution period. With this, when it is determined to be NO in Step s21, the attack evaluation value is not updated.

When it is determined to be YES in Step s22, the updater 320 updates the attack evaluation value in Step s23. On the other hand, when it is determined to be NO in Step s22, the updater 320 ends the processing concerning the target execution period. With this, when it is determined to be NO in Step s22, the attack evaluation value is not updated.

Note that, in a case where the target execution period is the first execution period, when the updater 320 determines YES in Step s21, the updater 320 executes Step s23 to update the attack evaluation value without executing Step s22. On the other hand, when the updater 320 determines NO in Step s21, the updater 320 ends the processing concerning the target execution period. Note that, in a case where the target execution period is the first execution period, when the updater 320 determines YES in Step s21, the updater 320 may end the processing concerning the target execution period without executing Steps s22 and s23.

As can be understood from the description above, in this example, when level change occurs a plurality of times in the target execution period (determined to be NO in Step s21), the updater 320 does not update the attack evaluation value. On the other hand, when level change occurs only once in the target execution period (determined to be YES in Step s21), the updater 320 updates the attack evaluation value only when level change occurs only once in an execution period immediately before the target execution period (determined to be YES in Step s22). Therefore, when level change occurs only once in the target execution period, the updater 320 does not update the attack evaluation value when level change does not occur in an execution period immediately before the target execution period (determined to be NO in Step s22). Further, when level change occurs only once in the target execution period, the updater 320 does not update the attack evaluation value when level change occurs a plurality of times in an execution period immediately before the target execution period (determined to be NO in Step s22).

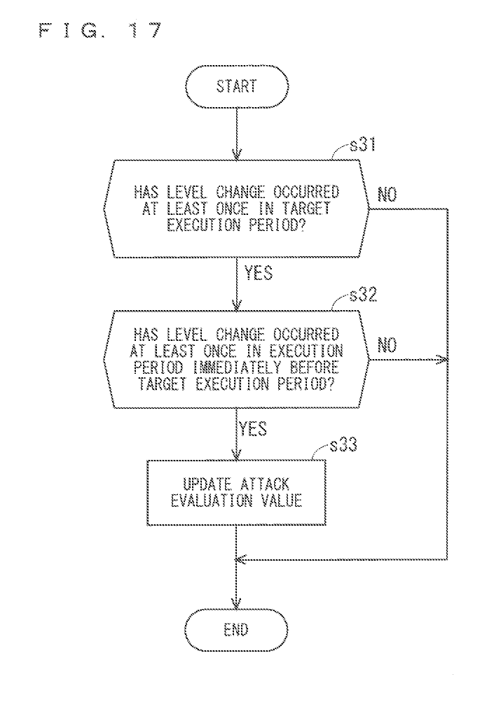

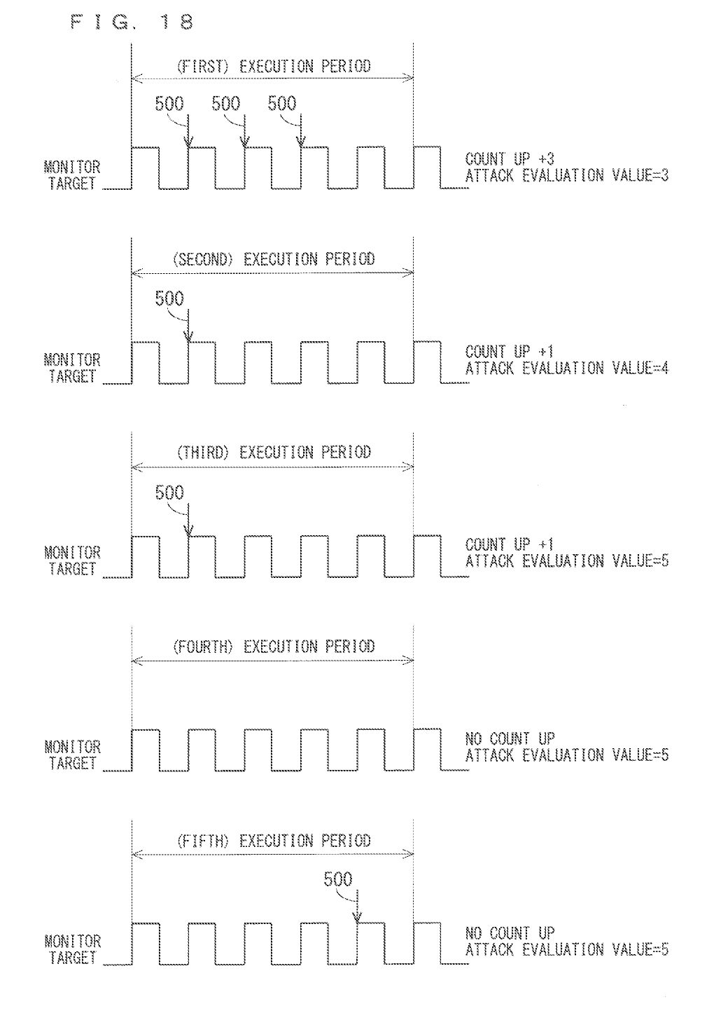

FIGS. 15 and 16 are each a diagram for illustrating one example of operation of the updater 320. In the examples of FIGS. 15 and 16, the attack evaluation value is 0, for example, at a time point when the first execution period after activation of the processing device 1 is started. Similarly, the following description is given assuming that the attack evaluation value at a time point when the first execution period is started is 0.

In the example of FIG. 15, level change occurs once in the first execution period, and therefore the updater 320 counts up the attack evaluation value only by +1 from “0” to bring the attack evaluation value to “1.” Level change occurs once in the second execution period, and level change also occurs once in the first execution period immediately before the second execution period. Therefore, the updater 320 counts up the attack evaluation value only by +1 from “1” to bring the attack evaluation value to “2” in accordance with the occurrence of the level change in the second execution period. Level change also occurs once in each of the third, fourth, and fifth execution periods, and therefore the attack evaluation value becomes “5” after the fifth execution period ends.

On the other hand, in the example of FIG. 16, level change does not occur in the first execution period, and therefore the updater 320 does not count up the attack evaluation value to maintain the attack evaluation value “0.” Level change occurs once in the second execution period; however, level change does not occur in the first execution period immediately before the second execution period. Therefore, the updater 320 does not count up the attack evaluation value even when level change occurs in the second execution period. Level change occurs once in the third execution period, and level change also occurs once in the second execution period immediately before the third execution period. Therefore, the updater 320 counts up the attack evaluation value only by +1 from “0” to bring the attack evaluation value to “1” in accordance with the occurrence of the level change in the third execution period. Level change occurs three times in the fourth execution period. Therefore, the updater 320 does not count up the attack evaluation value to maintain the attack evaluation value “1.” Level change occurs once in the fifth execution period; however, level change occurs a plurality of times in the fourth execution period immediately before the fifth execution period. Therefore, the updater 320 does not count up the attack evaluation value even when level change occurs in the fifth execution period. With this, the attack evaluation value becomes “1” at a time point when the fifth execution period ends.

When the attack evaluation value in the storage 310 is updated in accordance with characteristics of the specific-timing attack as described above, the specific-timing attack on the processing circuit 2 can be properly detected.

### Second Case of Sixth Example

As can be understood from the description above, it can be said that the specific-timing attack has two characteristics, namely, a characteristic that level change occurs only once in one execution period, and a characteristic that level change successively occurs in a repeatedly appearing plurality of execution periods. The former characteristic is hereinafter referred to as a “characteristic of the number of times of level change,” and the latter characteristic is referred to as a “characteristic of successiveness.”

In the above-mentioned first case of the sixth example, the attack evaluation value is updated in consideration of both of the characteristic of the number of times of level change and the characteristic of successiveness. In contrast, in the above-mentioned fifth example, the attack evaluation value is updated only in consideration of the characteristic of the number of times of level change, among the characteristic of the number of times of level change and the characteristic of successiveness.

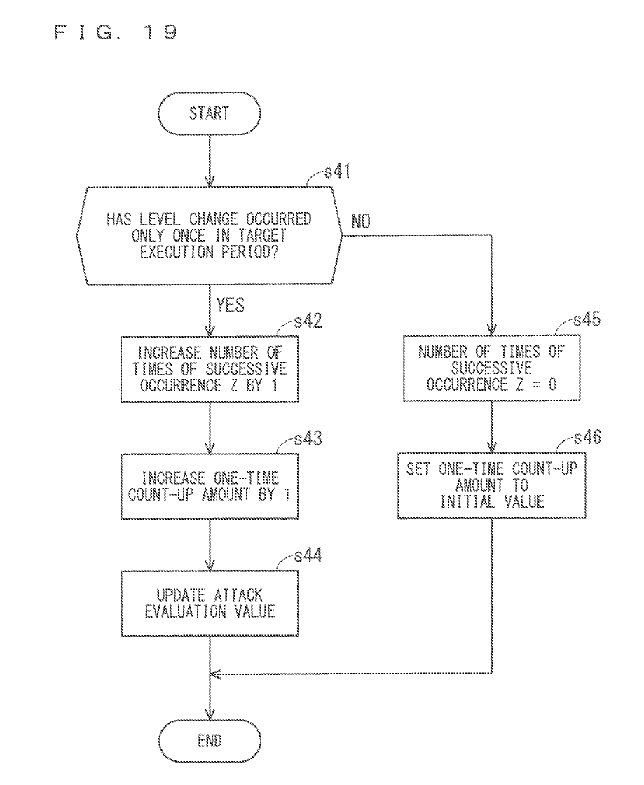

In this example, the updater 320 updates only in consideration of the characteristic of successiveness, among the characteristic of the number of times of level change and the characteristic of successiveness. FIG. 17 is a flowchart showing one example of processing concerning one execution period executed by the updater 320 according to this example. The updater 320 executes the processing shown in FIG. 17 in each execution period.

As shown in FIG. 17, in Step s31, the updater 320 determines whether or not level change has occurred at least once in a target execution period based on a detection result of the detector 300. When it is determined to be YES in Step s31, the updater 320 determines in Step s32 whether or not level change has occurred at least once in an execution period immediately before the target execution period based on the detection result of the detector 300. On the other hand, when it is determined to be NO in Step s31, the updater 320 ends the processing concerning the target execution period.

When it is determined to be YES in Step s32, the updater 320 updates the attack evaluation value in Step s33. On the other hand, when it is determined to be NO in Step s32, the updater 320 ends the processing concerning the target execution period.

Note that, in a case where the target execution period is the first execution period, when the updater 320 determines YES in Step s31, the updater 320 executes Step s33 to update the attack evaluation value without executing Step s32. On the other hand, when the updater 320 determines NO in Step s31, the updater 320 ends the processing concerning the target execution period. Note that, in a case where the target execution period is the first execution period, when the updater 320 determines YES in Step s31, the updater 320 may end the processing concerning the target execution period without executing Steps s32 and s33.

As can be understood from the description above, in a case where level change occurs at least once in a target execution period, the updater 320 according to this example updates the attack evaluation value in the storage 310 when level change occurs at least once in an execution period immediately before the target execution period. Further, in a case where level change occurs at least once in a target execution period, the updater 320 does not update the attack evaluation value in the storage 310 when level change does not occur in an execution period immediately before the target execution period.

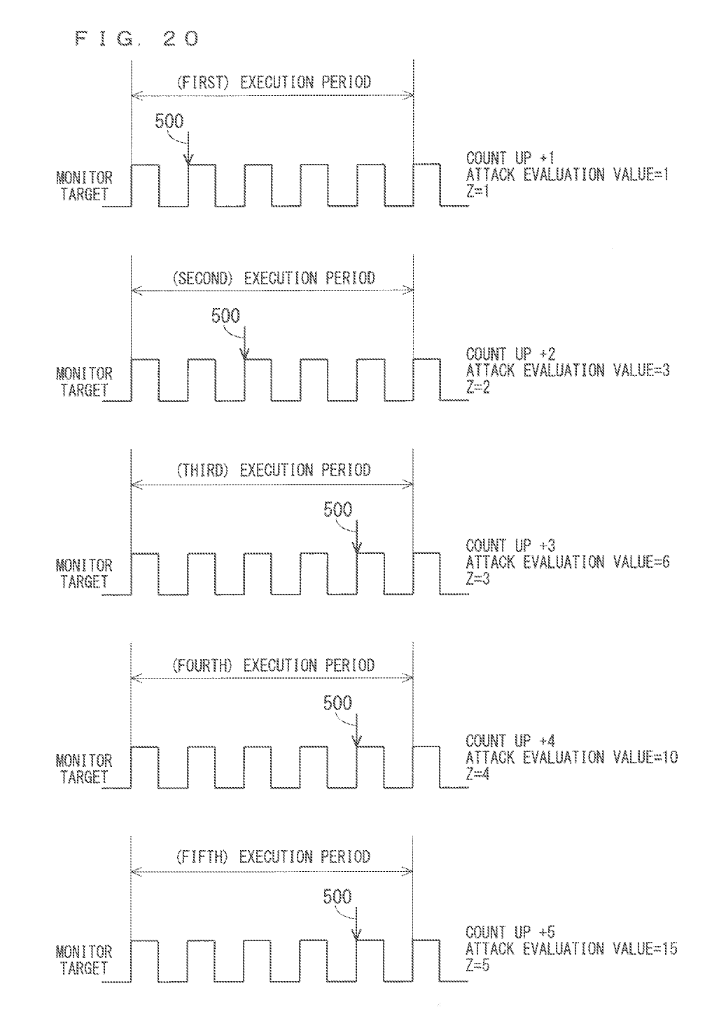

FIG. 18 is a diagram for illustrating one example of operation of the updater 320 according to this example. In the example of FIG. 18, level change occurs three times in the first execution period. For example, the updater 320 counts up the attack evaluation value only by +3 from “0” to bring the attack evaluation value to “3.” Level change occurs once in the second execution period, and level change occurs three times in the first execution period immediately before the second execution period. Therefore, the updater 320 counts up the attack evaluation value only by +1 from “3” to bring the attack evaluation value to “4” in accordance with the occurrence of the level change in the second execution period. Level change occurs once in the third execution period, and level change also occurs once in the second execution period immediately before the third execution period. Therefore, the updater 320 counts up the attack evaluation value only by +1 from “4” to bring the attack evaluation value to “5” in accordance with the occurrence of the level change in the third execution period. Level change does not occur in the fourth execution period. Therefore, the updater 320 does not count up the attack evaluation value. Level change occurs once in the fifth execution period; however, level change does not occur in the fourth execution period immediately before the fifth execution period. Therefore, the updater 320 does not count up the attack evaluation value even when level change occurs in the fifth execution period.

In this manner, when the attack evaluation value in the storage 310 is updated in accordance with the characteristic of successiveness of the specific-timing attack, the specific-timing attack on the processing circuit 2 can be properly detected.

Note that the updater 320 may count up the attack evaluation value only by +1 when level change occurs a plurality of times in one execution period. In this case, in the example of FIG. 18, the attack evaluation value is counted up only by +1 in accordance with the occurrence of the level change in the first execution period. Then, the attack evaluation value becomes “3” at a time point when the fifth execution period ends.

### Third Case of Sixth Example

In this example, the updater 320 increases a one-time update amount (i.e., a one-time count-up amount) of the attack evaluation value in accordance with the number of times of successive occurrence of level change in a repeatedly appearing plurality of execution periods in consideration of the characteristic of successiveness of the specific-timing attack. In other words, the updater 320 increases a one-time update amount (i.e., a one-time count-up amount) of the attack evaluation value in accordance with the number of times of successive occurrence of level change in a repeatedly appearing plurality of execution periods. The number of times of successive occurrence of level change in a repeatedly appearing plurality of execution periods may be hereinafter referred to as the “number of times of successive occurrence Z.”

In this example, the updater 320 increases a one-time count-up amount of the attack evaluation value by Y1 every time the number of times of successive occurrence Z is increased by X1. Each of X1 and Y1 is an integer equal to or greater than 1. Each of X1 and Y1 is set to 1, for example. Therefore, the updater 320 increases the one-time count-up amount of the attack evaluation value by 1 every time the number of times of successive occurrence Z is increased by 1. Note that the value of each of X1 and Y1 is not limited to the above. Further, X1 and Y1 may be values different from each other.

Further, in this example, the updater 320 takes the characteristic of the number of times of level change of the specific-timing attack into consideration, and when level change occurs a plurality of times in one execution period, the updater 320 assumes that level change did not occur in the execution period. With this, when level change occurs a plurality of times in a certain execution period, the attack evaluation value and the number of times of successive occurrence Z are not increased. In this example, it can be said that the updater 320 increases the one-time count-up amount of the attack evaluation value in accordance with the number of times only a one-time level change in one execution period successively occurs in a repeatedly appearing plurality of execution periods.

FIG. 19 is a flowchart showing one example of processing concerning one execution period executed by the updater 320 according to this example. The updater 320 executes the processing shown in FIG. 19 in each execution period.

As shown in FIG. 19, in Step s41, the updater 320 determines whether or not level change has occurred only once in a target execution period based on a detection result of the detector 300. When it is determined to be YES in Step s41, the updater 320 increases the number of times of successive occurrence Z by 1 in Step s42. Next, in Step s43, the updater 320 increases a one-time count-up amount of the attack evaluation value by 1. Then, in Step s44, the updater 320 updates the attack evaluation value. Specifically, the updater 320 counts up the attack evaluation value only by the one-time count-up amount. Note that the order of executing Steps s42 and s43 may be interchanged.

On the other hand, when it is determined to be NO in Step s41, the updater 320 sets the number of times of successive occurrence Z to zero in Step s45. Then, in Step s46, the updater 320 sets the one-time count-up amount to an initial value. The initial value is set to zero, for example. After that, the updater 320 ends the processing concerning the target execution period. Note that the order of executing Steps s45 and s46 may be interchanged.

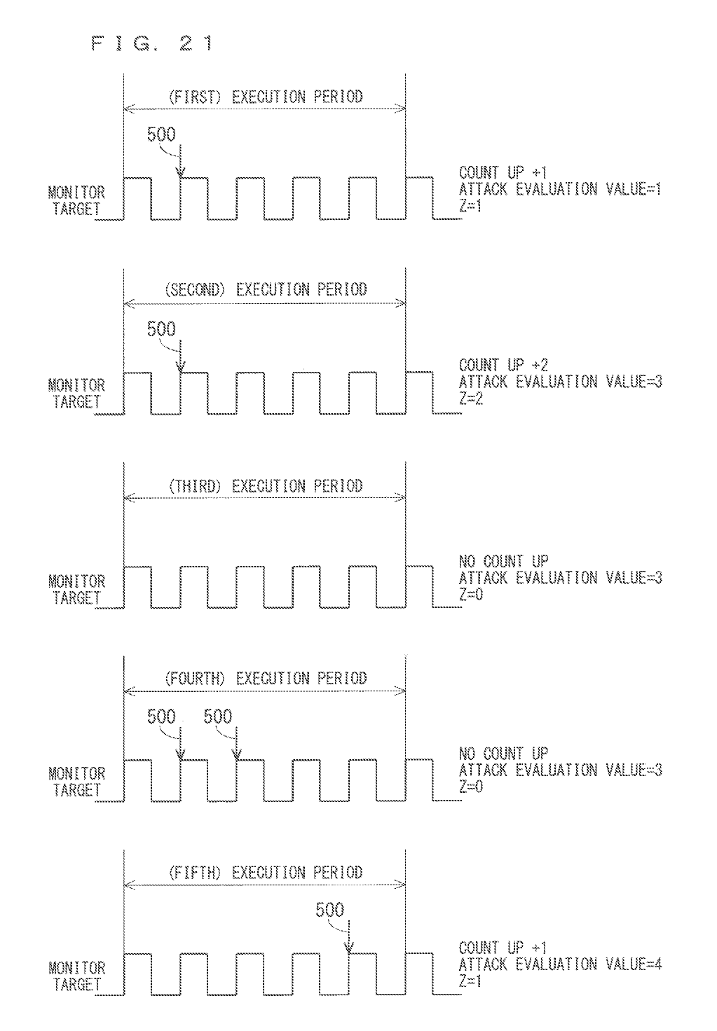

FIGS. 20 and 21 are each a diagram for illustrating one example of operation of the updater 320 according to this example. In the example of FIG. 20, there is successive occurrence of only a one-time level change in one execution period in each of the first to fifth execution periods. In the example of FIG. 21, level change occurs only once in each of the first, second, and fifth execution periods, level change does not occur in the third execution period, and level change occurs twice in the fourth execution period.

In the example of FIG. 20, the updater 320 increases the number of times of successive occurrence Z by 1 to bring the number of times of successive occurrence Z to “1” in accordance with the occurrence of the level change in the first execution period. Further, the updater 320 increases a one-time count-up amount by 1 from an initial value (zero) to bring the one-time count-up amount to “1.” Then, the updater 320 counts up the attack evaluation value only by +1 from “0” to bring the attack evaluation value to “1.”

The updater 320 increases the number of times of successive occurrence Z by 1 to bring the number of times of successive occurrence Z to “2” in accordance with the occurrence of the level change in the second execution period. Further, the updater 320 increases the one-time count-up amount by 1 to bring the one-time count-up amount to “2.” Then, the updater 320 counts up the attack evaluation value only by +2 from “1” to bring the attack evaluation value to “3.”

The updater 320 increases the number of times of successive occurrence Z by 1 to bring the number of times of successive occurrence Z to “3” in accordance with the occurrence of the level change in the third execution period. Further, the updater 320 increases the one-time count-up amount by 1 to bring the one-time count-up amount to “3.” Then, the updater 320 counts up the attack evaluation value only by +3 from “3” to bring the attack evaluation value to “6.”

The updater 320 increases the number of times of successive occurrence Z by 1 to bring the number of times of successive occurrence Z to “4” in accordance with the occurrence of the level change in the fourth execution period. Further, the updater 320 increases the one-time count-up amount by 1 to bring the one-time count-up amount to “4.” Then, the updater 320 counts up the attack evaluation value only by +4 from “6” to bring the attack evaluation value to “10.”

The updater 320 increases the number of times of successive occurrence Z by 1 to bring the number of times of successive occurrence Z to “5” in accordance with the occurrence of the level change in the fifth execution period. Further, the updater 320 increases the one-time count-up amount by 1 to bring the one-time count-up amount to “5.” Then, the updater 320 counts up the attack evaluation value only by +5 from “10” to bring the attack evaluation value to “15.”

In the example of FIG. 21, level change occurs only once in each of the first and second execution periods. Therefore, after the second execution period ends, similarly to the example of FIG. 20, the number of times of successive occurrence Z equals to 2, the one-time count-up amount becomes “2,” and the attack evaluation value becomes “3.” Level change does not occur in the third execution period, and therefore the updater 320 does not count up the attack evaluation value, brings the number of times of successive occurrence Z to “0,” and sets the one-time count-up amount to the initial value of “0.” Level change occurs a plurality of times in the fourth execution period, and therefore the updater 320 does not count up the attack evaluation value, brings the number of times of successive occurrence Z to “0,” and sets the one-time count-up amount to the initial value of “0.” Level change occurs once in the fifth execution period, and therefore the number of times of successive occurrence Z equals to 1, the one-time count-up amount becomes “1,” and the attack evaluation value is counted up only by +1 from “3” to become “4.”

In this manner, when the attack evaluation value in the storage 310 is updated in accordance with the characteristic of the number of times of level change and the characteristic of successiveness of the specific-timing attack, the specific-timing attack on the processing circuit 2 can be properly detected.

Note that, in Step s41 described above, the updater 320 may determine whether or not level change has occurred at least once in the target execution period. In this case, the characteristic of the number of times of level change of the specific-timing attack is not taken into consideration, and the number of times of successive occurrence Z, the one-time count-up amount, and the attack evaluation value are increased even when level change occurs a plurality of times in a one-time execution period. It can be said that the updater 320 increases the one-time count-up amount in accordance with the number of times at least a one-time level change in one execution period successively occurs in a repeatedly appearing plurality of execution periods.

### Fourth Case of Sixth Example

In this example, when there is successive non-occurrence of level change L times (L being an integer equal to or greater than 2) in a repeatedly appearing plurality of execution periods, the updater 320 decreases the attack evaluation value in the storage 310. L is set to “5,” for example. In this case, it can be said that the updater 320 decreases the attack evaluation value when the number of times of successive non-occurrence of level change in a repeatedly appearing plurality of execution periods is five times. The number of times of successive non-occurrence of level change in a repeatedly appearing plurality of execution periods may be hereinafter referred to as the “number of times of successive non-occurrence W.”

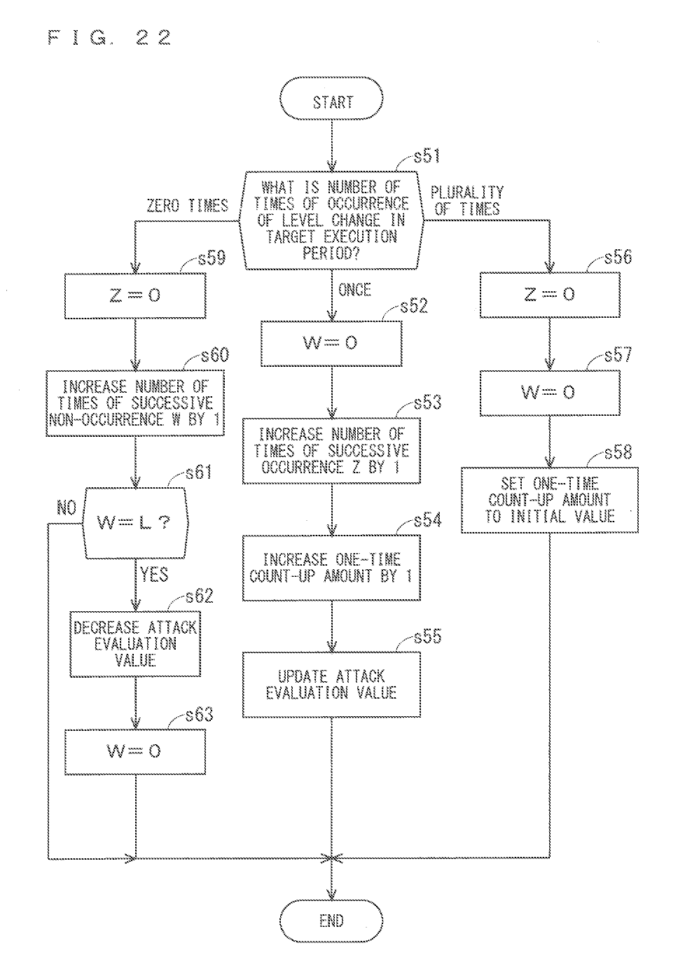

FIG. 22 is a flowchart showing one example of processing concerning one execution period executed by the updater 320 according to this example. The updater 320 executes the processing shown in FIG. 22 in each execution period.

As shown in FIG. 22, in Step s51, the updater 320 checks the number of times of occurrence of level change in a target execution period based on a detection result of the detector 300. When the updater 320 confirms that the number of times of occurrence of level change in the target execution period is once, the updater 320 sets the number of times of successive non-occurrence W to zero in Step s52. Next, in Step s53, the updater 320 increases the number of times of successive occurrence Z by 1. Next, in Step s54, the updater 320 increases a one-time count-up amount of the attack evaluation value by 1. Then, in Step s55, the updater 320 updates the attack evaluation value. After that, the updater 320 ends the processing concerning the target execution period. Note that Step s52 may be executed later than Step s53. Further, the order of executing Steps s53 and s54 may be interchanged.

When the updater 320 confirms in Step s51 that the number of times of occurrence of level change in the target execution period is a plurality of times, the updater 320 sets the number of times of successive occurrence Z to zero in Step s56. Next, in Step s57, the updater 320 sets the number of times of successive non-occurrence W to zero. Then, in Step s58, the updater 320 sets the one-time count-up amount to an initial value. After that, the updater 320 ends the processing concerning the target execution period. Note that the order of executing Steps s56 to s58 may be interchanged.

When the updater 320 confirms in Step s51 that level change does not occur in the target execution period, the updater 320 sets the number of times of successive occurrence Z to zero in Step s59. Next, in Step s60, the updater 320 increases the number of times of successive non-occurrence W by 1. Next, in Step s61, the updater 320 determines whether or not the number of times of successive non-occurrence W is L times. When the updater 320 determines that the number of times of successive non-occurrence W matches the L times, the updater 320 decreases the attack evaluation value in Step s62. In Step s62, the updater 320 decreases the attack evaluation value only by V, for example. V is an integer equal to or greater than 1. In Step s62, the updater 320 may reset the attack evaluation value. Specifically, the updater 320 may set the attack evaluation value to zero. After Step s62, in Step s63, the updater 320 resets the number of times of successive non-occurrence W to set the number of times of successive non-occurrence W to zero. After that, the updater 320 ends the processing concerning the target execution period. Note that Step s59 may be executed later than Step s60. Further, the order of executing Steps s62 and s63 may be interchanged.

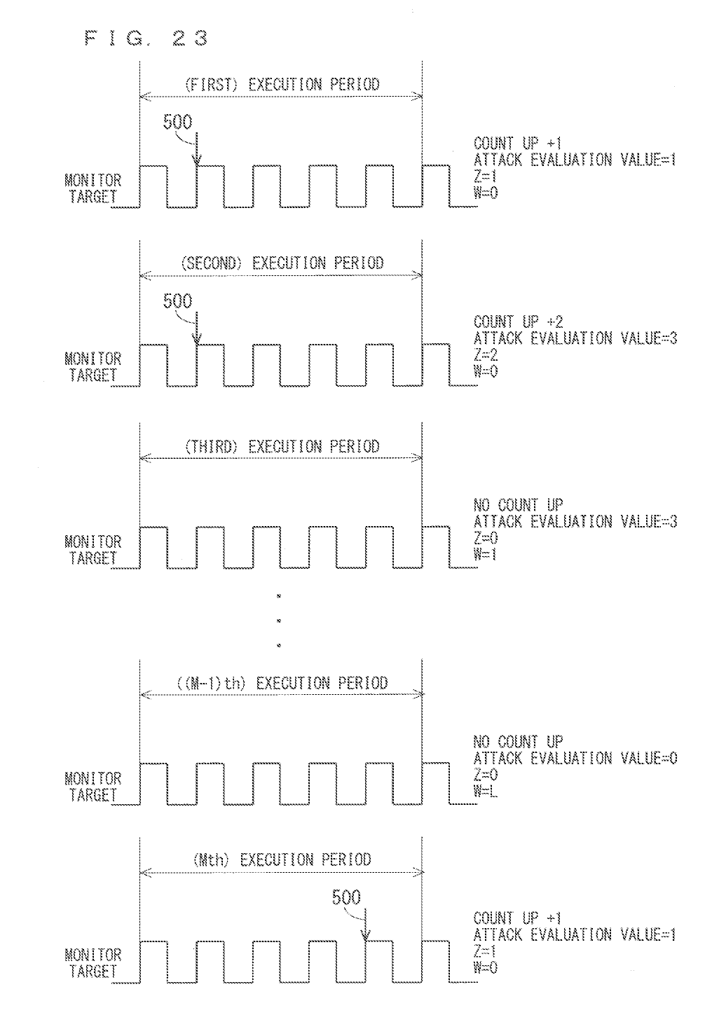

FIG. 23 is a diagram for illustrating one example of operation of the updater 320 according to this example. In the example of FIG. 23, the number of times of occurrence of level change in each of the first and second execution periods is once. Therefore, the attack evaluation value becomes “3,” the number of times of successive occurrence Z becomes “1,” and the number of times of successive non-occurrence W becomes “0” after the second execution period ends. Level change does not occur in the third execution period, and therefore the attack evaluation value is not counted up, the number of times of successive occurrence Z is set to zero, and the number of times of successive non-occurrence W is increased to become “1.” After that, when there is successive non-occurrence of level change until the (M−1)th execution period to bring the number of times of successive non-occurrence W to L times, the attack evaluation value is decreased. In the example of FIG. 23, the attack evaluation value is reset to be set to zero. Then, when level change occurs only once in the Mth execution period, the attack evaluation value is increased only by +1 to become “1,” and the number of times of successive occurrence Z becomes “1.”

When the attack evaluation value in the storage 310 is decreased when there is successive non-occurrence of level change in a repeatedly appearing plurality of execution periods as described above, the specific-timing attack on the processing circuit 2 can be properly detected.

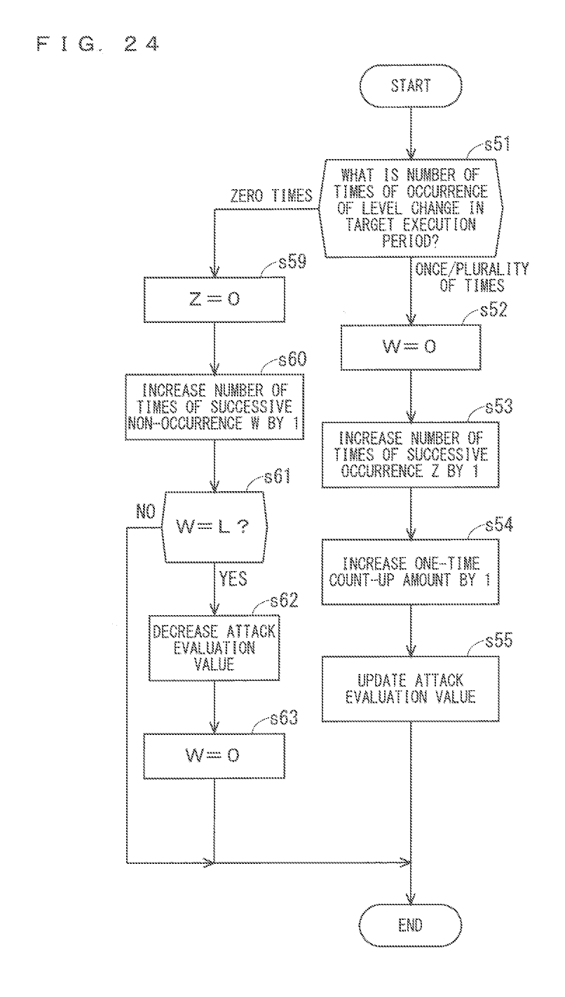

Note that, when it is confirmed in Step s51 that the number of times of occurrence of level change in the target execution period is a plurality of times in the flowchart shown in FIG. 22, Steps s52 to s55 may be executed instead of Steps s56 to s58. FIG. 24 is a flowchart showing one example of operation of the updater 320 in this case. Note that Step s51 shown in FIG. 24 is substantially the same processing as Step s31 shown in FIG. 17 described above. “ZERO TIMES” in Step s51 corresponds to “NO” in Step s31, and “ONCE/PLURALITY OF TIMES” in Step s51 corresponds to “YES” in Step s31.

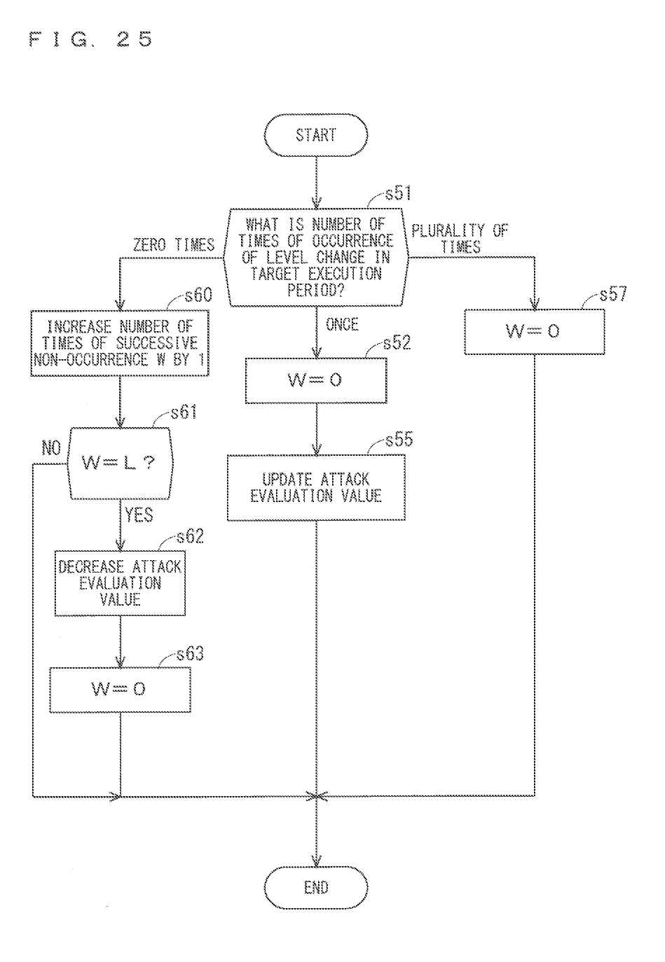

Further, the processing of increasing the one-time count-up amount in accordance with the number of times of successive occurrence Z may not be executed in the flowchart shown in FIG. 22. FIG. 25 is a flowchart showing one example of operation of the updater 320 in this case. The flowchart shown in FIG. 25 is a flowchart in which Steps s53, s54, s56, s58, and s59 are deleted in the flowchart shown in FIG. 22 described above. In Step s55 of FIG. 25, the updater 320 increases the attack evaluation value only by +1.

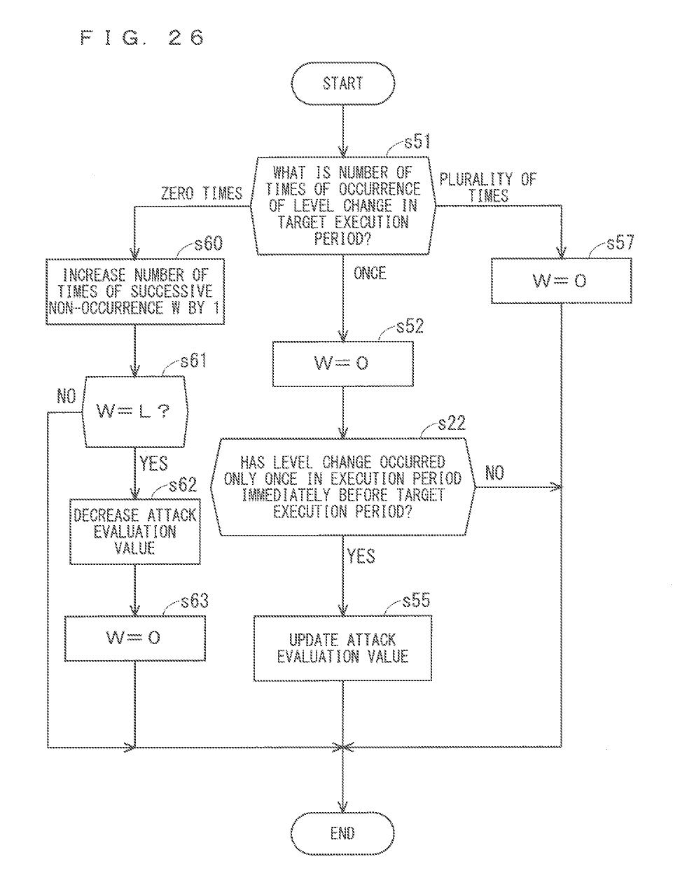

Further, in the flowchart shown in FIG. 14 described above, the attack evaluation value may be decreased when the number of times of successive non-occurrence W becomes the L times. FIG. 26 is a flowchart showing one example of operation of the updater 320 in this case. The flowchart shown in FIG. 26 is a flowchart in which Step s22 of FIG. 14 is added between Steps s52 and s55 in the flowchart shown in FIG. 25. Step s51 shown in FIG. 26 is a step corresponding to Step s21 shown in FIG. 14. In the example of FIG. 26, when it is determined to be YES in Step s22, Step s55 is executed, and the attack evaluation value is increased only by +1. On the other hand, when it is determined to be NO in Step s22, the processing concerning the target execution period ends.

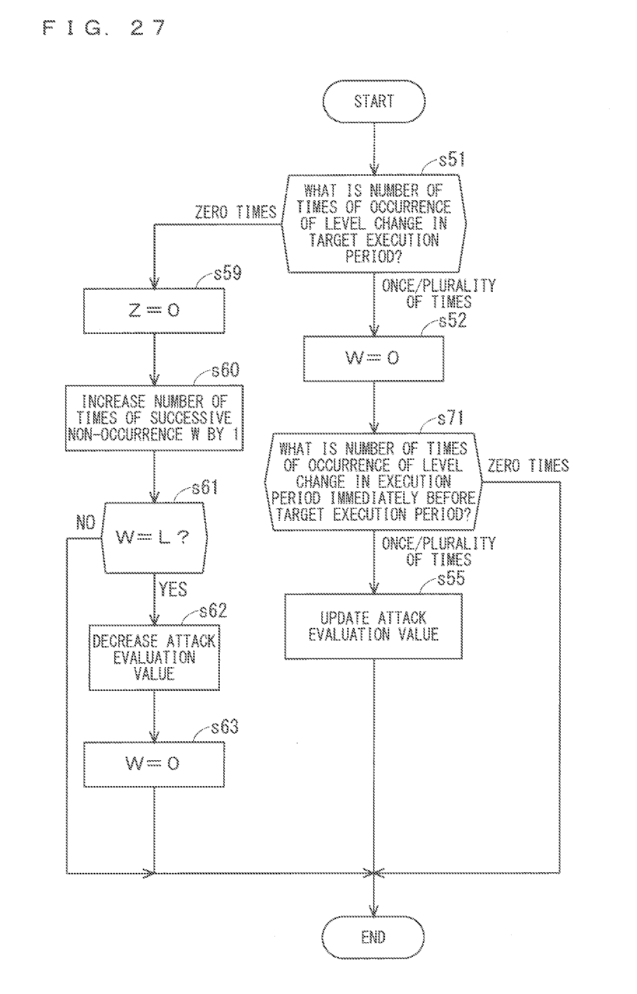

Further, in the flowchart shown in FIG. 17 described above, the attack evaluation value may be decreased when the number of times of successive non-occurrence W becomes the L times. FIG. 27 is a flowchart showing one example of operation of the updater 320 in this case. The flowchart shown in FIG. 27 is a flowchart in which Step s71 is executed instead of Steps s53 and s54 in the flowchart shown in FIG. 24 described above. Step s51 of FIG. 27 corresponds to Step s31 of FIG. 17, and Step s71 of FIG. 27 is substantially the same processing as Step s32 of FIG. 17. In Step s71, the updater 320 checks the number of times of occurrence of level change in an execution period immediately before the target execution period. When the updater 320 confirms in Step s71 that the number of times of occurrence of level change in the execution period immediately before the target execution period is once or a plurality of times, the updater 320 executes Step s55 to update the attack evaluation value. On the other hand, when the updater 320 confirms in Step s71 that level change does not occur in the execution period immediately before the target execution period, the updater 320 executes the processing concerning the target execution period.

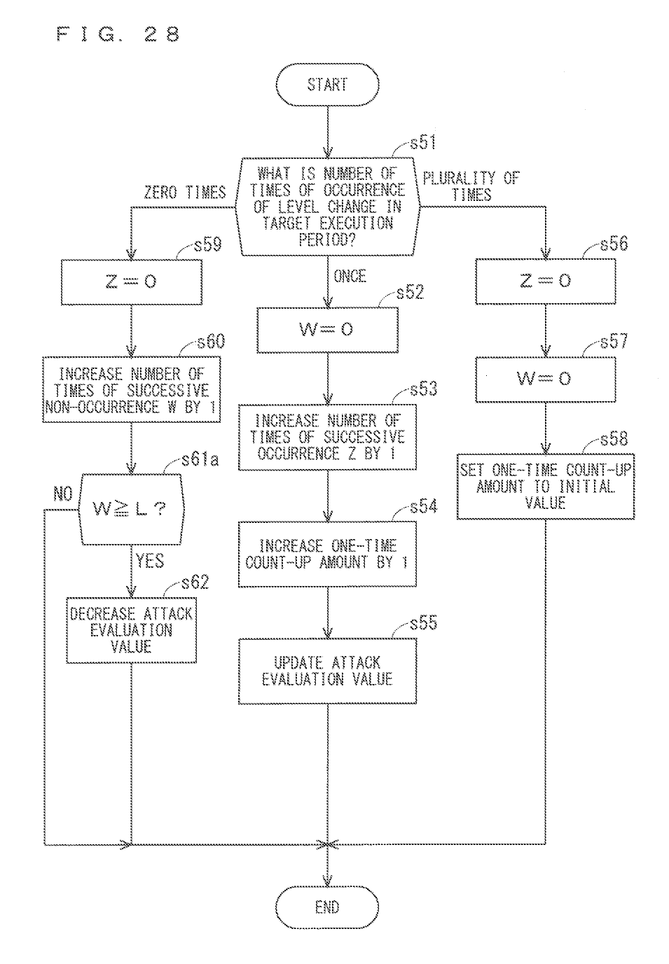

In the examples shown in FIGS. 22 and 24 to 27 described above, when the number of times of successive non-occurrence W becomes the L times, the number of times of successive non-occurrence W is reset irrespective of the number of times of occurrence of level change in the following execution period. However, the number of times of successive non-occurrence W may not be reset. In this case, the updater 320 may decrease the attack evaluation value when the number of times of successive non-occurrence W is equal to or more than the L times. FIG. 28 is a flowchart, corresponding to FIG. 22, showing operation of the updater 320 in this case. The flowchart shown in FIG. 28 is a flowchart in which Step s61a is executed instead of Step s61, and Step s63 is deleted in the flowchart shown in FIG. 22. As shown in FIG. 28, after Step s60, the updater 320 determines in Step s61a whether or not the number of times of successive non-occurrence W is equal to or more than the L times. When it is determined to be YES in Step s61a, the updater 320 executes Step s62 to decrease the attack evaluation value. After Step s62, the processing concerning the target execution period ends. On the other hand, when it is determined to be NO in Step s61a, the processing concerning the target execution period ends. Note that Step s61a may be executed instead of Step s61, and Step s63 may be deleted also in the flowcharts shown in FIGS. 24 to 27.

As in the above-mentioned second example, the above-mentioned first to fourth cases of the sixth example may also be applied to the attack detector 30 in which the storage 310 includes the first-type storage 311 and the second-type storage 312. In this case, similarly to the first to fourth cases of the sixth example, the updater 320 updates the first attack evaluation value in the first-type storage 311 based on successiveness of occurrence of level change between a repeatedly appearing plurality of execution periods. Further, similarly to the first to fourth cases of the sixth example, the updater 320 updates the second attack evaluation value in the second-type storage 312 based on successiveness of occurrence of level change between a repeatedly appearing plurality of execution periods.

Further, even when the determination unit 330 determines a degree of a risk of an attack on the processing circuit 2 as in the third example, the updater 320 can update the attack evaluation value in the storage 310 based on successiveness of detection of level change between a repeatedly appearing plurality of execution periods similarly to the first to fourth cases of the sixth example.

### Seventh Example

In the above-mentioned third case of the sixth example, the updater 320 increases the one-time count-up amount in accordance with the number of times of successive occurrence Z in consideration of the characteristic of successiveness of the specific-timing attack. In contrast, in this example, the updater 320 decreases a threshold value used in the attack determination processing in accordance with the number of times of successive occurrence Z in consideration of the characteristic of successiveness of the specific-timing attack.

In this example, the updater 320 decreases a threshold value by Y2 every time the number of times of successive occurrence Z is increased by X2. Each of X2 and Y2 is an integer equal to or greater than 1. Each of X2 and Y2 is set to 1, for example. Therefore, the updater 320 decreases the threshold value used in the attack determination processing executed by the determination unit 330 by 1 every time the number of times of successive occurrence Z is increased by 1. Note that the value of each of X2 and Y2 is not limited to the above. Further, X2 and Y2 may be values different from each other.

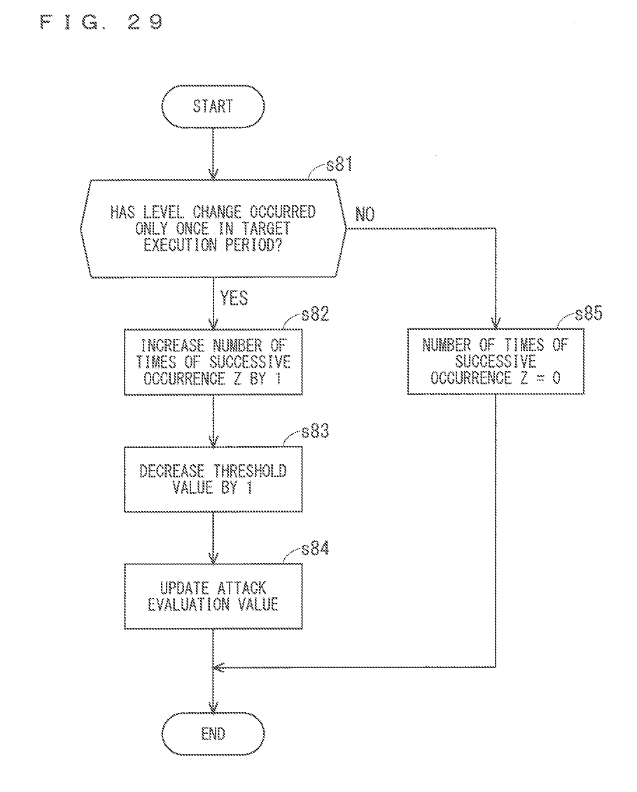

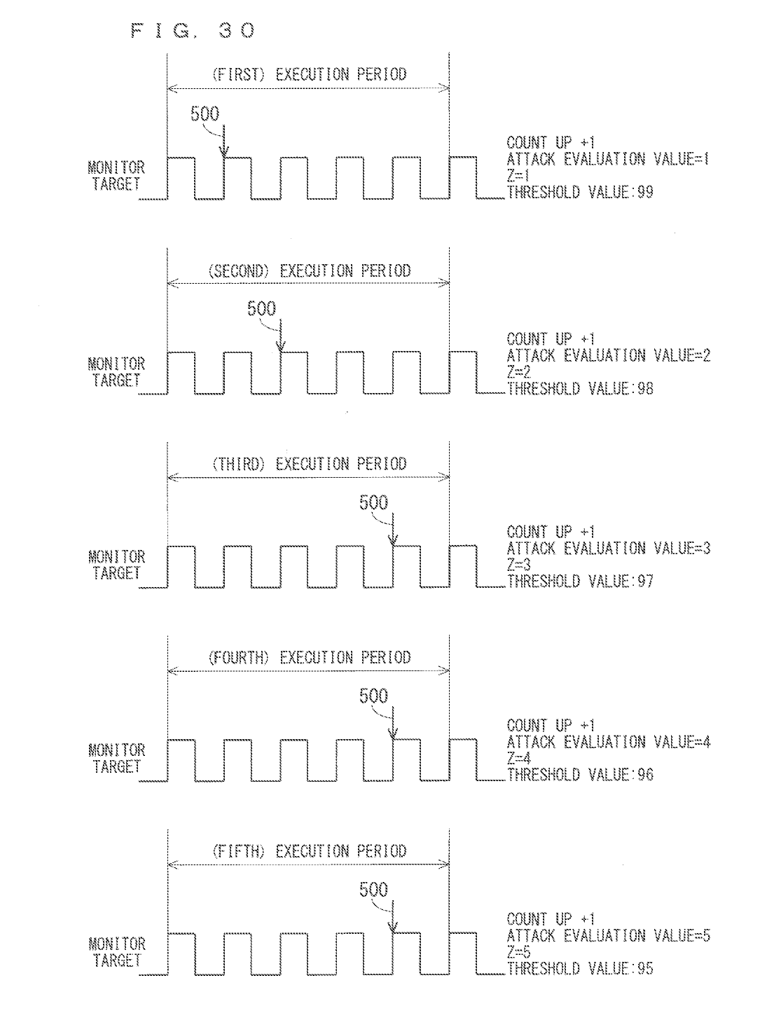

FIG. 29 is a flowchart showing one example of processing concerning one execution period executed by the updater 320 according to this example. The updater 320 executes the processing shown in FIG. 29 in each execution period.

As shown in FIG. 29, in Step s81, the updater 320 determines whether or not level change has occurred only once in a target execution period. When it is determined to be YES in Step s81, the updater 320 increases the number of times of successive occurrence Z by 1 in Step s82. Next, in Step s83, the updater 320 decreases a threshold value used in the attack determination processing by 1. Then, in Step s84, the updater 320 updates the attack evaluation value. Specifically, the updater 320 counts up the attack evaluation value only by a one-time count-up amount. Note that the order of executing Steps s82 to s84 may be interchanged.

On the other hand, when it is determined to be NO in Step s81, the updater 320 sets the number of times of successive occurrence Z to zero in Step s85. After that, the updater 320 ends the processing concerning the target execution period.

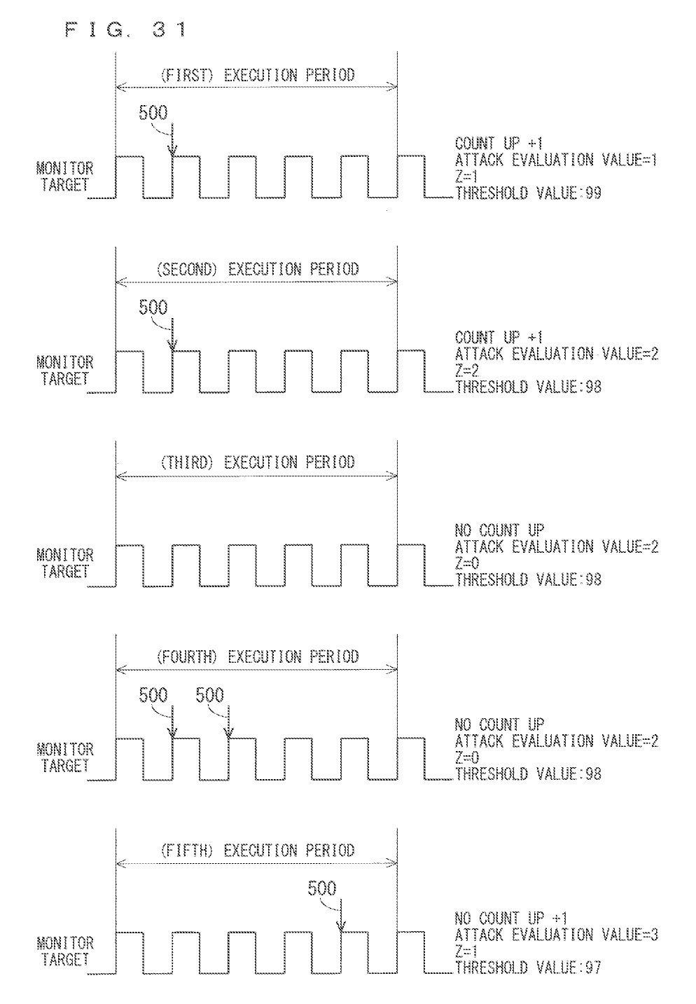

FIGS. 30 and 31 are each a diagram for illustrating one example of operation of the updater 320 according to this example. In the examples of FIGS. 30 and 31, an initial value of the threshold value used in the attack determination processing is set to “100.”

In the example of FIG. 30, only a one-time level change in one execution period successively occurs in each of the first to fifth execution periods. Therefore, both of the attack evaluation value and the number of times of successive occurrence Z become “5” after the fifth execution period ends. Further, the threshold value becomes is decreased by “5” from the initial value of “100” to become “95.”

In the example of FIG. 31, level change occurs only once in each of the first and second execution periods. Therefore, both of the attack evaluation value and the number of times of successive occurrence Z become “2,” and the threshold value becomes “98” after the second execution period ends. Level change does not occur in the third execution period and level change occurs a plurality of times in the fourth execution period. Therefore, the attack evaluation value becomes “2,” the number of times of successive occurrence Z becomes “0,” and the threshold value becomes “98” after the fourth execution period ends. Level change occurs once in the fifth execution period, and therefore the attack evaluation value is counted up only by +1 from “2” to become “3.” Then, the number of times of successive occurrence Z equals to 1, and the threshold value is decreased by 1 to become “97.”

In this manner, in this example, the threshold value used in the attack determination processing is decreased in accordance with the characteristic of the number of times of level change and the characteristic of successiveness of the specific-timing attack. Therefore, the specific-timing attack on the processing circuit 2 can be properly detected.

Note that, in Step s81 described above, the updater 320 may determine whether or not level change has occurred at least once in the target execution period. In this case, the characteristic of the number of times of level change of the specific-timing attack is not taken into consideration, and the number of times of successive occurrence Z and the attack evaluation value are increased and the threshold value is decreased even when level change occurs a plurality of times in a one-time execution period. It can be said that the updater 320 decreases the threshold value in accordance with the number of times at least a one-time level change in one execution period successively occurs in a repeatedly appearing plurality of execution periods.

Further, as in the above-mentioned second example, this example may also be applied to the attack detector 30 in which the storage 310 includes the first-type storage 311 and the second-type storage 312. In this case, similarly to the above, the updater 320 may decrease the first-type threshold value to be compared with the first attack evaluation value in the first-type storage 311 in accordance with the number of times of successive occurrence Z. Further, the updater 320 may decrease the second-type threshold value to be compared with the second attack evaluation value in the second-type storage 312 in accordance with the number of times of successive occurrence Z.

Further, as in the above-mentioned third example, this example may also be applied to the attack detector 30 that determines a degree of a risk of an attack on the processing circuit 2 by using the determination unit 330 using a plurality of threshold values that are different from each other. In this case, the updater 320 may decrease each of the plurality of threshold values different from each other used by the determination unit 330 in accordance with the number of times of successive occurrence Z similarly to the above.

### Eighth Example

In the specific-timing attack, the attacker may cause level change aiming at the same timing in a repeatedly appearing plurality of execution periods. For example, when target processing executed in an execution period is encryption processing in accordance with AES with a key length of 128 bits, the attacker may cause level change at timing when the tenth round of the encryption processing is executed in each of the repeatedly appearing plurality of execution periods to carry out an attack on the processing circuit 2.

In view of this, in this example, the attack detector 30 divides each execution period into a plurality of partial periods. In this example, each execution period is divided into first to Kth partial periods. K is an integer equal to or greater than 2. The first to Kth partial periods forming one execution period appear from start to end of the execution period in the mentioned order. Concerning each of the plurality of partial periods, the attack detector 30 stores an attack evaluation value indicating a degree of probability that an attack on the processing circuit 2 has occurred in the partial period in the storage 310. Concerning each of the plurality of partial periods, the attack detector 30 updates the attack evaluation value corresponding to the partial period in accordance with occurrence of level change in the partial period. Then, the attack detector 30 determines whether or not an attack has occurred on the processing circuit 2 based on the attack evaluation values concerning the plurality of partial periods. With this, the specific-timing attack can be more properly detected. The operation of the attack detector 30 according to this example is described in detail below.

<One Example of Update Method of Attack Evaluation Value>

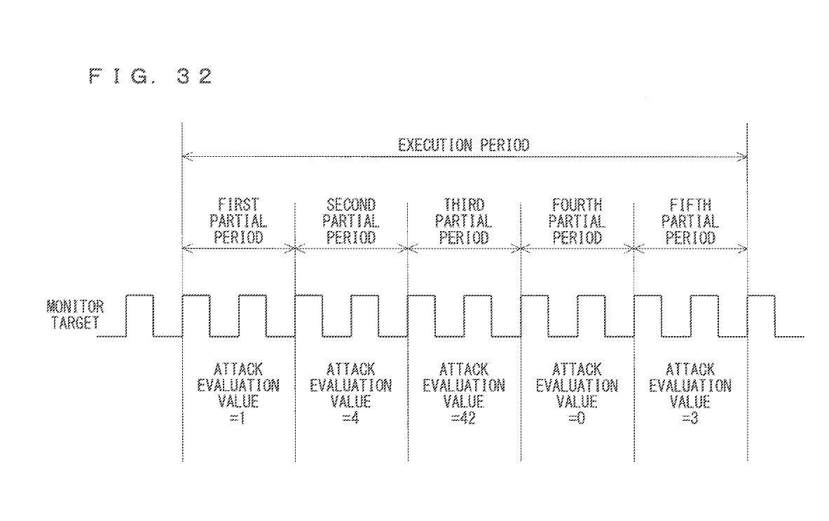

In this example, the storage 310 stores K attack evaluation values that correspond to respective first to Kth partial periods. Concerning each partial period of the first to Kth partial periods, the updater 320 updates the attack evaluation value corresponding to the partial period in the storage 310 in accordance with occurrence of level change in the partial period. The methods of updating the K attack evaluation values that correspond to the respective first to Kth partial periods are the same. FIG. 32 is a diagram showing one example of the K attack evaluation values at a certain time point. In the example of FIG. 32, K equals to 5, and one execution period is divided in first to fifth partial periods. In the example of FIG. 32, five attack evaluation values that correspond to the respective first to fifth partial periods are “1,” “4,” “42,” “0,” and “3.” In the example of FIG. 32, it can be said that there is high probability that an attack has occurred in the third partial period among the first to fifth partial periods.

As the method of updating the attack evaluation value, various update methods described above can be adopted. For example, similarly to FIG. 4 described above, the updater 320 may update the attack evaluation value corresponding to a kth partial period (1<k<K) every time level change occurs in the kth partial period. One kth partial period to be described may be hereinafter referred to as a “target kth partial period.” Further, the attack evaluation value corresponding to the kth partial period may be hereinafter referred to as a “kth-corresponding attack evaluation value.”

As in the above-mentioned sixth example, the updater 320 may update the kth-corresponding attack evaluation value based on successiveness of occurrence of level change between a repeatedly appearing plurality of kth partial periods. The operation of the updater 320 in this case is basically operation in which the target execution period is replaced with the target kth partial period in the details described in the sixth example. The execution period repeatedly appears, and therefore the kth partial period also repeatedly appears.

For example, a case of replacing the target execution period with the target kth partial period in the flowchart of FIG. 14 of the first case of the sixth example is considered. In this case, in Step s21, the updater 320 determines whether or not level change has occurred only once in a target kth partial period. Further, in Step s22, the updater 320 determines whether or not level change has occurred only once in a kth partial period immediately before the target kth partial period. Then, in Step s23, the updater 320 updates the kth-corresponding attack evaluation value. The updater 320 performs the processing concerning the kth partial period shown in FIG. 14 in which the target execution period is replaced with the target kth partial period in each of the repeatedly appearing plurality of kth partial periods. Then, the updater 320 performs similar processing in each of the first to Kth partial periods.

Further, a case of replacing the target execution period with the target kth partial period in the flowchart of FIG. 17 of the second case of the sixth example is considered. In this case, in Step s31, the updater 320 determines whether or not level change has occurred at least once in the target kth partial period. Further, in Step s32, the updater 320 determines whether or not level change has occurred at least once in a kth partial period immediately before the target kth partial period. Then, in Step s33, the updater 320 updates the kth-corresponding attack evaluation value. The updater 320 performs the processing concerning the kth partial period shown in FIG. 17 in which the target execution period is replaced with the target kth partial period in each of the repeatedly appearing plurality of kth partial periods. Then, the updater 320 performs similar processing in each of the first to Kth partial periods.

Further, a case of replacing the target execution period with the target kth partial period in the flowchart of FIG. 19 of the third case of the sixth example is considered. In this case, in Step s41, the updater 320 determines whether or not level change has occurred only once in the target kth partial period. In Step s42, the updater 320 increases the number of times of successive occurrence Z concerning the kth partial period by 1. Here, the number of times of successive occurrence Z concerning the kth partial period refers to the number of times of successive occurrence of level change in a repeatedly appearing plurality of kth partial periods. In Step s43, the updater 320 increases a one-time count-up amount of the kth-corresponding attack evaluation value by 1. In Step s44, the updater 320 updates the kth-corresponding attack evaluation value. In Step s45, the updater 320 sets the number of times of successive occurrence Z concerning the kth partial period to zero. In Step s46, the updater 320 sets the one-time count-up amount of the kth-corresponding attack evaluation value to an initial value. The updater 320 performs the processing concerning the kth partial period shown in FIG. 19 in which the target execution period is replaced with the target kth partial period in each of the repeatedly appearing plurality of kth partial periods. Then, the updater 320 performs similar processing in each of the first to Kth partial periods.

Further, a case of replacing the target execution period with the target kth partial period in the flowcharts of FIGS. 22 and 24 to 27 of the fourth case of the sixth example is considered. In this case, in Step s51, the updater 320 checks the number of times of occurrence of level change in the target kth partial period. In Steps s52, s57, and s63, the number of times of successive non-occurrence W concerning the kth partial period is set to zero. Here, the number of times of successive non-occurrence W concerning the kth partial period refers to the number of times of successive non-occurrence of level change in a repeatedly appearing plurality of kth partial periods. In Step s53, the updater 320 increases the number of times of successive occurrence Z concerning the kth partial period by 1. In Step s54, the updater 320 increases a one-time count-up amount of the kth-corresponding attack evaluation value by 1. In Step s55, the updater 320 updates the kth-corresponding attack evaluation value. In Steps s56 and s59, the updater 320 sets the number of times of successive occurrence Z concerning the kth partial period to zero. In Step s58, the updater 320 sets the one-time count-up amount of the kth-corresponding attack evaluation value to an initial value. In Step s60, the updater 320 increases the number of times of successive non-occurrence W concerning the target kth partial period by 1. In Step s61, the updater 320 determines whether or not the number of times of successive non-occurrence W concerning the target kth partial period is the L times. In Step s62, the updater 320 decreases the kth-corresponding attack evaluation value. In Step s22 (FIG. 26), the updater 320 determines whether or not level change has occurred only once in a kth partial period immediately before the target kth partial period. In Step s71 (FIG. 27), the updater 320 checks the number of times of occurrence of level change in the kth partial period immediately before the target kth partial period. The updater 320 performs the processing concerning the kth partial period shown in the flowcharts of FIGS. 22 and 24 to 27 in which the target execution period is replaced with the target kth partial period in each of the repeatedly appearing plurality of kth partial periods. Then, the updater 320 performs similar processing in each of the first to Kth partial periods. Similarly to FIG. 28 described above, the updater 320 may determine whether or not the number of times of successive non-occurrence W concerning the target kth partial period is equal to or more than the L times in Step s61a instead of Step s61, and may not execute Step s63.

Note that, in consideration of the characteristic of the number of times of level change of the specific-timing attack, the updater 320 may not update the kth-corresponding attack evaluation value when level change occurs in a plurality of partial periods including the kth partial period in the execution period in each of the methods of updating the kth-corresponding attack evaluation value described above.

<One Example of Attack Determination Processing>

The determination unit 330 according to this example determines whether or not an attack has occurred on the processing circuit 2 based on the first-corresponding attack evaluation value to the Kth-corresponding attack evaluation value in the storage 310 in the attack determination processing. For example, the determination unit 330 calculates the sum of the first-corresponding attack evaluation value to the Kth-corresponding attack evaluation value in the attack determination processing. Then, when the calculated sum is less than a predetermined value, the determination unit 330 determines that an attack on the processing circuit 2 has not occurred. The predetermined value is set to 50, for example, but is not limited thereto. On the other hand, when the calculated sum is equal to or greater than the predetermined value, the determination unit 330 calculates a ratio with respect to the calculated sum as an evaluation value ratio for each of the first-corresponding attack evaluation value to the Kth-corresponding attack evaluation value. Then, when an evaluation value ratio equal to or greater than a threshold value TH exists in the evaluation value ratios concerning the first-corresponding attack evaluation value to the Kth-corresponding attack evaluation value, the determination unit 330 determines that an attack on the processing circuit 2 has occurred. On the other hand, when an evaluation value ratio equal to or greater than the threshold value TH does not exist in the evaluation value ratios concerning the first-corresponding attack evaluation value to the Kth-corresponding attack evaluation value, the determination unit 330 determines that an attack on the processing circuit 2 has not occurred. The threshold value TH is set to 80%, for example. Note that the threshold value TH may be set to a value other than 80%.

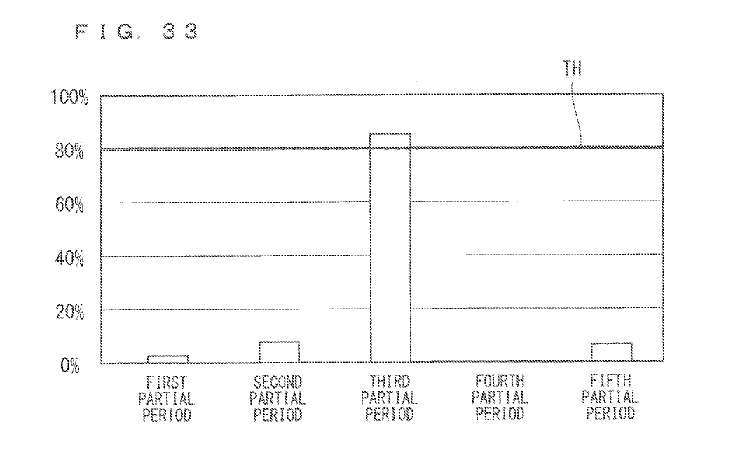

FIG. 33 is a diagram showing evaluation value ratios in the example of FIG. 32. The vertical axis of FIG. 33 represents an evaluation value ratio concerning the attack evaluation value in each partial period. In the example of FIG. 32, the sum of the first-corresponding attack evaluation value to the fifth-corresponding attack evaluation value is “50.” Further, the evaluation value ratios concerning the respective first-corresponding attack evaluation value to the fifth-corresponding attack evaluation value are 2%, 8%, 84%, 0%, and 6%. Therefore, as shown in FIG. 33, the evaluation value ratio concerning the third-corresponding attack evaluation value in the third partial period is equal to or greater than the threshold value TH. In a case where the first-corresponding attack evaluation value to the fifth-corresponding attack evaluation value when the attack determination processing is executed are similar to the values as in FIG. 32, it is determined that an attack on the processing circuit 2 has occurred. Note that the method of determining whether or not an attack has occurred on the processing circuit 2 based on the first-corresponding attack evaluation value to the Kth-corresponding attack evaluation value is not limited to the above example.

In this manner, in this example, whether or not an attack has occurred on the processing circuit 2 is determined based on the attack evaluation values concerning the plurality of partial periods forming the execution period. Therefore, the specific-timing attack of causing level change aiming at the same timing in the repeatedly appearing plurality of execution periods can be properly detected.

### Ninth Example

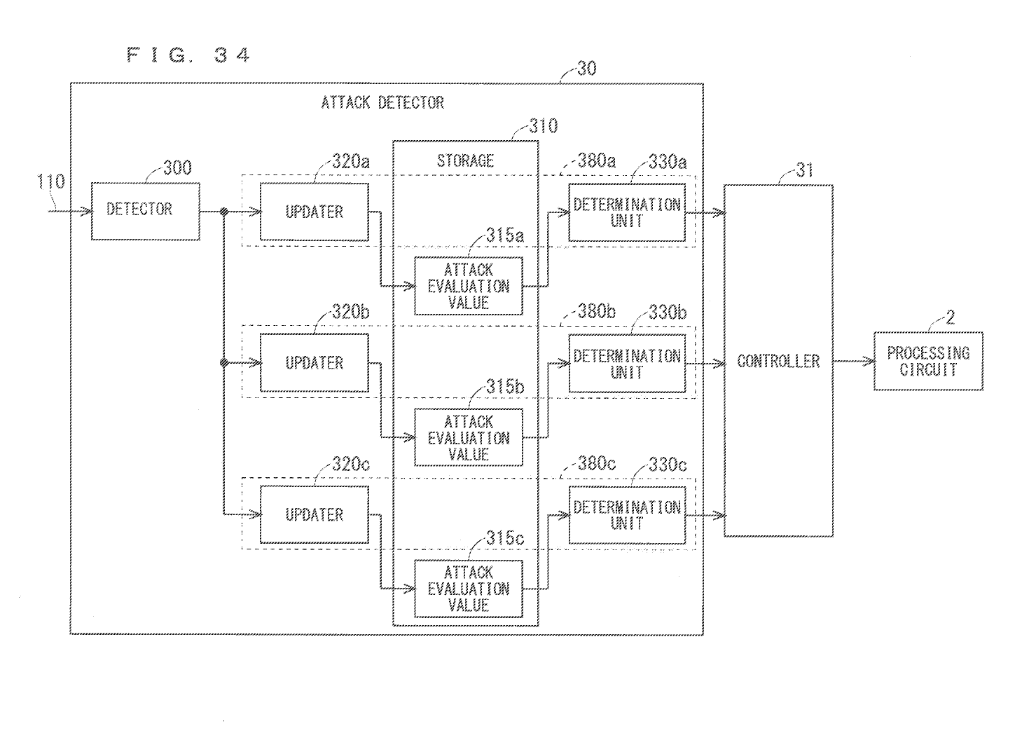

FIG. 34 is a diagram mainly showing one example of a configuration of the attack detector 30 of the controller 3 included in the processing device 1 according to this example. As shown in FIG. 34, in this example, the attack detector 30 includes a plurality of updaters 320a, 320b, and 320c, and a plurality of determination units 330a, 330b, and 330c.

The updater 320a and the determination unit 330a form an update determination unit 380a that updates an attack evaluation value 315a stored in the storage 310 and performs attack determination processing based on the attack evaluation value 315a. The updater 320b and the determination unit 330b form an update determination unit 380b that updates an attack evaluation value 315b stored in the storage 310 and performs attack determination processing based on the attack evaluation value 315b. The updater 320c and the determination unit 330c form an update determination unit 380c that updates an attack evaluation value 315c stored in the storage 310 and performs attack determination processing based on the attack evaluation value 315c. Operations of the plurality of update determination units 380a to 380c are different from each other.

For example, the updater 320a and the determination unit 330a included in the update determination unit 380a operate similarly to the updater 320 and the determination unit 330 according to the above-mentioned first example. Specifically, during activation of the processing device 1, the updater 320a constantly performs update processing of updating the attack evaluation value 315a every time level change occurs. The determination unit 330a determines whether or not an attack on the processing circuit 2 has occurred based on a comparison result between the attack evaluation value 315a and a threshold value.

For example, the updater 320b and the determination unit 330b included in the update determination unit 380b operate similarly to the updater 320 and the determination unit 330 according to the above-mentioned sixth example. Specifically, the updater 320b updates the attack evaluation value 315b in the storage 310 based on successiveness of occurrence of level change between the repeatedly appearing plurality of execution periods. In this example, for example, the updater 320b increases a one-time count-up amount of the attack evaluation value 315a in accordance with the number of times of successive occurrence Z, similarly to the third case of the sixth example. The determination unit 330b determines whether or not an attack on the processing circuit 2 has occurred based on a comparison result between the attack evaluation value 315b and a threshold value.

For example, the updater 320c and the determination unit 330c included in the update determination unit 380c operate similarly to the updater 320 and the determination unit 330 according to the above-mentioned eighth example. In this case, the storage 310 stores K attack evaluation values 315c that correspond to the respective first to Kth partial periods forming the execution period. Concerning each of the K attack evaluation values 315c in the storage 310, the updater 320c updates the attack evaluation value 315c in accordance with occurrence of level change in a partial period corresponding to the attack evaluation value 315c. The determination unit 330c calculates the sum of the K attack evaluation values 315c in the attack determination processing. Then, when the calculated sum is less than a predetermined value, the determination unit 330c determines that an attack on the processing circuit 2 has not occurred. On the other hand, when the calculated sum is equal to or greater than the predetermined value, the determination unit 330c calculates a ratio with respect to the calculated sum as an evaluation value ratio for each of the K attack evaluation values 315c. Then, when an evaluation value ratio equal to or greater than a threshold value TH exists in the evaluation value ratios concerning the K attack evaluation values, the determination unit 330c determines that an attack on the processing circuit 2 has occurred. On the other hand, when an evaluation value ratio equal to or greater than the threshold value TH does not exist in the evaluation value ratios concerning the K attack evaluation values, the determination unit 330c determines that an attack on the processing circuit 2 has not occurred.

In this example, when the determination unit 330a determines that an attack on the processing circuit 2 has occurred, the controller 31 stops the operation of the processing circuit 2, as in the first example. Further, when the determination unit 330b determines that an attack on the processing circuit 2 has occurred, the controller 31 stops the operation of the processing circuit 2. Further, when the determination unit 330c determines that an attack on the processing circuit 2 has occurred, the controller 31 stops the operation of the processing circuit 2.

In this manner, in this example, the plurality of update determination units that perform different operations are provided. Therefore, a plurality of types of fault injection attacks on the processing circuit 2 can be detected.

For example, the update determination unit 380a can properly detect a fault injection attack of causing level change in a period other than the execution period in which the target processing is performed.

Further, the update determination unit 380b can properly detect a specific-timing attack of causing level change a plurality of times over the entire execution period. For example, the attacker may repeatedly cause level change from start to end of an execution period to determine timing to finally carry out an attack in the execution period based on an operation state of the processing circuit 2 at the time. For example, a case where the target processing is encryption processing in accordance with AES with a key length of 128 bits is considered. In this case, the attacker may repeatedly cause level change from start to end of the execution period of the encryption processing to determine that timing at which the tenth round of the encryption processing is executed is timing to finally carry out an attack based on an operation state of the processing circuit 2 at the time. The update determination unit 380b can detect the specific-timing attack before the timing to finally carry out an attack in the execution period is determined.

Further, the update determination unit 380c can properly detect a specific-timing attack of causing level change aiming at certain specific timing in the execution period.

Note that the controller 31 may change control over the processing circuit 2 depending on cases. Such cases include a case where it is determined that an attack has occurred in the determination unit 330a, a case where it is determined that an attack has occurred in the determination unit 330b, and a case where it is determined that an attack has occurred in the determination unit 330c. For example, a case where an attack is carried out on the encryption processing performed by the processing circuit 2 is considered. In this case, when it is determined that an attack has occurred in the determination unit 330a, the controller 31 makes the processing circuit 2 change execution timing of the encryption processing, for example. Further, when it is determined that an attack has occurred in the determination unit 330b, the controller 31 makes the processing circuit 2 change a key used in the encryption processing, for example. Further, when it is determined that an attack has occurred in the determination unit 330c, the controller 31 stops the operation of the processing circuit 2, for example. Combination of the details of the control over the processing circuit 2 is not limited to the above.

In the above examples, the attack detector 30 includes three update determination units that perform different operations from each other. However, the attack detector 30 may include two update determination units that perform different operations from each other, and may include four or more update determination units that perform different operations from each other. Further, the plurality of attack evaluation values 315a, 315b, and 315c managed respectively the update determination units 380a, 380b, and 380c may be stored in a plurality of storages different from each other. In this case, the plurality of storages may include the first-type storage, and may include the second-type storage.

While the processing device 1 has been described in detail, the foregoing description is in all aspects illustrative, and the present invention is not limited thereto. The above-mentioned various modifications may be applied in combination on the condition that the combination is consistent. It is therefore understood that numerous unillustrated modifications can be devised without departing from the scope of the invention.

What is claimed is:

1. An attack detector comprising first circuitry, the first circuitry being configured to:
detect occurrence of level change of power or a signal supplied to a predetermined circuit;
store a first attack evaluation value indicating a degree of probability that an attack on the predetermined circuit has occurred;
update the first attack evaluation value based on a detection result of the occurrence of the level change; and
perform first determination of determining whether or not the attack has occurred based on the first attack evaluation value.

2. The attack detector according to claim 1, wherein
the first circuitry increases the first attack evaluation value every time the level change occurs.

3. The attack detector according to claim 1, wherein
the first circuitry updates the first attack evaluation value in accordance with the occurrence of the level change in an execution period in which the predetermined circuit performs predetermined processing.

4. The attack detector according to claim 3, wherein
the predetermined processing comprising encryption processing, conditional branch processing, or processing of writing to a storage area.

5. The attack detector according to claim 3, wherein
the first circuitry is notified of the execution period from the predetermined circuit.

6. The attack detector according to claim 3, wherein
the first circuitry acquires a power consumption waveform of the predetermined circuit, and estimates the execution period based on the acquired power consumption waveform.

7. The attack detector according to claim 3, wherein
the first circuitry does not update the first attack evaluation value when the level change occurs a plurality of times in one execution period of a repeatedly appearing plurality of the execution periods.

8. The attack detector according to claim 3, wherein
the first circuitry updates the first attack evaluation value based on successiveness of the occurrence of the level change between a repeatedly appearing plurality of the execution periods.

9. The attack detector according to claim 8, wherein
in a case where the level change occurs in one execution period, the first circuitry increases the first attack evaluation value when the level change occurs in an execution period immediately before the one execution period, and
in a case where the level change occurs in one execution period, the first circuitry does not increase the first attack evaluation value when the level change does not occur in an execution period immediately before the one execution period.

10. The attack detector according to claim 8, wherein
the first circuitry sets a one-time update amount of the first attack evaluation value to a value according to the number of times of successive occurrence of the level change in the repeatedly appearing plurality of the execution periods.

11. The attack detector according to claim 8, wherein
the first circuitry decreases the first attack evaluation value when there is successive non-occurrence of the level change in the repeatedly appearing plurality of the execution periods.

12. The attack detector according to claim 3, wherein
in the first determination, the first circuitry compares the first attack evaluation value and a threshold value, and determines whether or not the attack has occurred based on a comparison result of the comparison, and
the first circuitry decreases the threshold value in accordance with the number of times of successive occurrence of the level change in a repeatedly appearing plurality of the execution periods.

13. The attack detector according to claim 3, wherein
concerning each of a plurality of partial periods obtained by dividing the execution period into a plurality of periods, the first circuitry stores the first attack evaluation value indicating a degree of probability that the attack has occurred in each of the plurality of partial periods,
concerning each of the plurality of partial periods, the first circuitry updates the first attack evaluation value in accordance with the occurrence of the level change in each of the plurality of partial periods, and
in the first determination, the first circuitry determines whether or not the attack has occurred based on the attack evaluation value concerning each of the plurality of partial periods.

14. The attack detector according to claim 1, wherein
the first circuitry comprises a first storage circuit in which stored information is not cleared in response to power disconnection and reset of the attack detector,
the first attack evaluation value is stored in the first storage circuit,
in the first determination, the first circuitry compares the first attack evaluation value and a threshold value, and determines whether or not the attack has occurred based on a comparison result of the comparison, and
the first circuitry decreases the threshold value every time the attack detector is restarted.

15. The attack detector according to claim 1, wherein
the first circuitry comprises a first storage circuit in which stored information is cleared in response to power disconnection and reset of the attack detector, and a second storage circuit in which stored information is not cleared in response to power disconnection and reset of the attack detector,
the first attack evaluation value is stored in the first storage circuit,
the second storage circuit stores a second attack evaluation value indicating a degree of probability that the attack has occurred,
the first circuitry updates the second attack evaluation value in the second storage circuit based on the detection result, and
in the first determination, the first circuitry determines whether or not the attack has occurred based on the first attack evaluation value in the first storage circuit and the second attack evaluation value in the second storage circuit.

16. The attack detector according to claim 1, wherein
the first circuitry determines a degree of a risk of the attack based on a comparison result between the first attack evaluation value and each of a plurality of threshold values that are different from each other.

17. The attack detector according to claim 1, wherein
the first circuitry stores a second attack evaluation value indicating a degree of probability that the attack has occurred,
the first circuitry updates the second attack evaluation value based on the detection result, and
the first circuitry performs second determination of determining whether or not the attack has occurred based on the second attack evaluation value.

18. A controller comprising:
the attack detector of claim 16; and
a second circuitry configured to control the predetermined circuit when it is determined that the attack has occurred in the attack detector, wherein
the second circuitry changes control over the predetermined circuit depending on the degree of the risk determined by the first circuitry.

19. A controller comprising:
the attack detector of claim 17; and
a second circuitry configured to control the predetermined circuit when it is determined that the attack has occurred in the attack detector, wherein
the second circuitry changes control over the predetermined circuit depending on cases, the cases including a first case where it is determined that the attack has occurred in the first determination, and a second case where it is determined that the attack has occurred in the second determination.

20. An attack detection method used in an attack detector configured to detect an attack on a predetermined circuit, the attack detection method comprising:
detecting occurrence of level change of power or a signal supplied to the predetermined circuit;
updating an attack evaluation value indicating a degree of probability that the attack has occurred based on a detection result of the occurrence of the level change; and
determining whether or not the attack has occurred based on the updated attack evaluation value.
